(19) United States
(12) Patent Application Publication
(10) Pub. No.: US 2024/0338095 A1
(43) Pub. Date: Oct. 10, 2024

(54) ELECTRONIC DEVICE AND DRIVING METHOD THEREOF

(71) Applicant: SAMSUNG DISPLAY CO., LTD., YONGIN-SI (KR)

(72) Inventors: KYOUNGHUN BEEN, Yongin-si (KR); HYOJIN LEE, Yongin-si (KR); YOUNGSIK KIM, Yongin-si (KR); BYEONGKYU JEON, Yongin-si (KR)

(21) Appl. No.: 18/423,672

(22) Filed: Jan. 26, 2024

(30) Foreign Application Priority Data
Apr. 5, 2023 (KR) 10-2023-0044932

(51) Int. Cl. G06F 3/041; G06F 3/044

(52) U.S. Cl. CPC G06F 3/041662; G06F 3/04184; G06F 3/0446; G06F 2203/04101

(57) ABSTRACT

Disclosed is an electronic device which include a display layer that includes a plurality of pixels, a sensor layer disposed on the display layer and includes a plurality of first electrodes and a plurality of second electrodes, a display driver that drives the display layer, and a sensor driver that drives the sensor layer and selectively operates, in a proximity sensing mode, in a first mode or a second mode different from the first mode. When the electronic device enters the proximity sensing mode, the display layer operates in an active period during which data are received from the display driver and a blank period during which the data are not received. The sensor driver operates in the second mode in a period overlapping the blank period.

### CROSS-REFERENCE TO RELATED APPLICATION(S)

This application claims priority under 35 U.S.C. § 119 to Korean Patent Application No. 10-2023-0044932 filed on Apr. 5, 2023, in the Korean Intellectual Property Office, the disclosure of which is incorporated by reference herein in its entirety.

### TECHNICAL FIELD

Embodiments of the present disclosure described herein relate to an electronic device with a proximity sensing function.

### DISCUSSION OF RELATED ART

Multimedia electronic devices such as a television, a mobile phone, a tablet computer, a navigation system, and a game console may display images and may provide a touch-based input scheme. This input scheme allows a user to enter information or a command intuitively, conveniently, and easily, in addition to/alternative to typical input devices such as a button, a keyboard, and a mouse.

### SUMMARY

Embodiments of the present disclosure provide an electronic device including a sensor layer with a proximity sensing function, and a driving method of the electronic device.

According to an embodiment, an electronic device may include a display layer that includes a plurality of pixels, a sensor layer disposed on the display layer and includes a plurality of first electrodes and a plurality of second electrodes, a display driver that drives the display layer, and a sensor driver that drives the sensor layer and selectively operates, during a proximity sensing mode, in a first mode or a second mode different from the first mode. When the electronic device enters the proximity sensing mode, the display layer may operate in an active period where data are received from the display driver and a blank period where the data are not received. The sensor driver may operate in the second mode in a period overlapping the blank period.

The first mode may include a touch sensing period and a first proximity sensing period, the second mode may include a second proximity sensing period, and a duration of the second proximity sensing period may equal or exceed a duration of the first proximity sensing period.

The sensor driver may operate in the first mode to obtain a plurality of reference proximity signals and may determine whether the display layer operates in the blank period based on the plurality of reference proximity signals. When it is determined that the display layer operates in the blank period, the sensor driver may operate in the second mode.

The plurality of reference proximity signals may include a first reference proximity signal measured in a first active period, a second reference proximity signal measured in a second active period following the first active period, a third reference proximity signal measured in a first blank period following the second active period, and a fourth reference proximity signal measured in a second blank period following the first blank period. The sensor driver may determine whether the display layer operates in the blank period by comparing the first to fourth reference proximity signals. When it is determined that the display layer operates in the blank period, the sensor driver may operate in the second mode from a third blank period following the second blank period.

The touch sensing period may include a mutual-cap sensing period and a self-cap sensing period.

The second mode may further include a mutual-cap sensing period and a self-cap sensing period.

The second proximity sensing period may overlap a plurality of blank periods, which are contiguous.

The electronic device may further include a main driver that controls an operation of the display driver and an operation of the sensor driver, and the main driver may determine whether an image displayed in the display layer is a still image or a video.

When the image is the still image, a frame frequency of the display layer may be set to a first frequency. When the image is the video, the frame frequency of the display layer may be set to a second frequency. The second frequency may be higher than the first frequency.

The first frequency may be 20 Hz, and the second frequency may be 30 Hz.

The sensor driver may operate in synchronization with the display driver.

According to an embodiment, an electronic device may include a display layer that includes a plurality of pixels and operates at a variable frame frequency including a first frame frequency and a second frame frequency lower than the first frame frequency, and a sensor layer that is disposed on the display layer and selectively operates in a first mode or a second mode different from the first mode in a proximity sensing mode. The first mode may include a touch sensing period and a first proximity sensing period, the second mode may include a second proximity sensing period, and duration of the second proximity sensing period may be longer than or equal to duration of the first proximity sensing period.

The display layer operating at the second frame frequency may operate in an active period where data are received and a blank period where the data are not received, the first proximity sensing period may overlap the active period in time, and the second proximity sensing period may overlap the blank period in time.

The second proximity sensing period may overlap a plurality of contiguous blank periods.

The electronic device may further include a sensor driver that drives the sensor layer. The sensor driver may obtain a plurality of reference proximity signals and may determine whether the display layer operates in the blank period based on the plurality of reference proximity signals. When it is determined that the display layer operates in the blank period, the sensor driver may change an operating mode of the sensor layer from the first mode to the second mode.

The electronic device may further include a display driver that drives the display layer, a sensor driver that drives the sensor layer, and a main driver that controls an operation of the display driver and an operation of the sensor driver. The main driver may determine whether an image displayed in the display layer is a still image or a video. When the image is the still image, the second frame frequency of the display layer may be set to a first frequency. When the image is the video, the second frame frequency of the display layer may be set to a second frequency higher than the first frequency.

According to an embodiment, a driving method of an electronic device may include displaying an image through a display layer, and driving a sensor layer disposed on the display layer, in a first mode or a second mode different from the first mode in a proximity sensing mode. The displaying of the image through the display layer may include operating in an active period where the display layer receives data and a blank period where the display layer does not receive the data, when the electronic device enters the proximity sensing mode. The driving of the sensor layer may include operating in the second mode in a period overlapping the blank period.

The first mode may include a touch sensing period and a first proximity sensing period, the second mode may include a second proximity sensing period, and duration of the second proximity sensing period may equal or exceed a duration of the first proximity sensing period.

The driving of the sensor layer may further include operating in the first mode to obtain a plurality of reference proximity signals, determining whether the display layer operates in the blank period, based on the plurality of reference proximity signals, and changing from the first mode to the second mode to operate, when it is determined that the display layer operates in the blank period.

The displaying of the image through the display layer may further include determining whether the image is a still image, when the electronic device enters the proximity sensing mode, setting a frame frequency of the display layer to a first frequency, when the image is the still image, and setting the frame frequency of the display layer to a second frequency, when the image is a video. The second frequency may be higher than the first frequency.

### BRIEF DESCRIPTION OF THE FIGURES

The above and other aspects and features of the present disclosure will become apparent by describing in detail embodiments thereof with reference to the accompanying drawings.

FIG. 1 is a perspective view of an electronic device according to an embodiment of the present disclosure.

FIG. 2 is a diagram describing an operation of an electronic device according to an embodiment of the present disclosure.

FIG. 3A is a cross-sectional view of an electronic device according to an embodiment of the present disclosure.

FIG. 3B is a cross-sectional view of an electronic device according to an embodiment of the present disclosure.

FIG. 4 is a cross-sectional view of an electronic device according to an embodiment of the present disclosure.

FIG. 5 is a block diagram of a display layer and a display driver according to an embodiment of the present disclosure.

FIG. 6 is a block diagram of a sensor layer and a sensor driver according to an embodiment of the present disclosure.

FIG. 7A is a cross-sectional view of a sensor layer according to an embodiment of the present disclosure, which is taken along line II-II′ of FIG. 6.

FIG. 7B is a cross-sectional view of a sensor layer according to an embodiment of the present disclosure, which is taken along line II-II′ of FIG. 6.

FIG. 8 is an enlarged plan view of area XX′ illustrated in FIG. 6.

FIG. 9 is a plan view of a sensing unit according to an embodiment of the present disclosure.

FIG. 10 is an enlarged plan view of a cross area of a sensing unit according to an embodiment of the present disclosure.

FIG. 11 is a diagram for describing operations of a display driver and a sensor driver according to an embodiment of the present disclosure.

FIG. 12 is a flowchart for describing an operation in a proximity sensing mode according to an embodiment of the present disclosure.

FIG. 13A a diagram for describing operations of a display driver and a sensor driver according to an embodiment of the present disclosure.

FIG. 13B is a diagram for describing operations of a display driver and a sensor driver according to an embodiment of the present disclosure.

FIG. 14A a diagram for describing operations of a display driver and a sensor driver according to an embodiment of the present disclosure.

FIG. 14B is a diagram for describing operations of a display driver and a sensor driver according to an embodiment of the present disclosure.

FIG. 15A a diagram for describing operations of a display driver and a sensor driver according to an embodiment of the present disclosure.

FIG. 15B is a diagram for describing operations of a display driver and a sensor driver according to an embodiment of the present disclosure.

FIG. 16 is a flowchart for describing an operation in a proximity sensing mode according to an embodiment of the present disclosure.

FIG. 17 is a diagram for describing operations of a display driver and a sensor driver according to an embodiment of the present disclosure.

FIG. 18 is a flowchart for describing an operation in a proximity sensing mode according to an embodiment of the present disclosure.

### DETAILED DESCRIPTION

Herein, the expression that a first component (or area, layer, part, portion, etc.) is “on”, “connected with”, or “coupled to” a second component means that the first component is directly on, connected with, or coupled to the second component or means that a third component is disposed therebetween.

Like reference numerals refer to like components. Also, in drawings, the thickness, ratio, and dimension of components are exaggerated for effectiveness of description of technical contents. The term “and/or” includes one or more combinations in each of which associated elements are defined.

Although the terms “first”, “second”, etc. may be used to describe various components, the components should not be construed as being limited by the terms. The terms are only used to distinguish one component from another component. For example, without departing from the scope and spirit of the invention, a first component may be referred to as a “second component”, and similarly, the second component may be referred to as the “first component”. The articles “a”, “an”, and “the” are singular in that they have a single referent, but the use of the singular form in the specification should not preclude the presence of more than one referent.

Also, the terms “under”, “below”, “on”, “above”, etc. are used to describe the correlation of components illustrated in drawings. The terms that are relative in concept are described based on a direction shown in drawings.

It will be further understood that the terms “comprises”, “includes”, “have”, etc. specify the presence of stated features, numbers, steps, operations, elements, components, or a combination thereof but do not preclude the presence or addition of one or more other features, numbers, steps, operations, elements, components, or a combination thereof.

Unless otherwise defined, all terms (including technical terms and scientific terms) used in the specification have the same meaning as commonly understood by one skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

The term “unit” may mean a software component or a hardware component that performs a specific function. The hardware component may include, for example, a field-programmable gate array (FPGA) or an application-specific integrated circuit (ASIC). The software component may refer to an executable code and/or data used by the executable code in an addressable storage medium. Thus, software components may be, for example, object-oriented software components, class components, and task components and may include processes, functions, properties, procedures, subroutines, program code segments, drivers, firmware, microcode, circuits, data, database, data structures, tables, arrays, or variables.

Below, embodiments of the present disclosure will be described with reference to drawings.

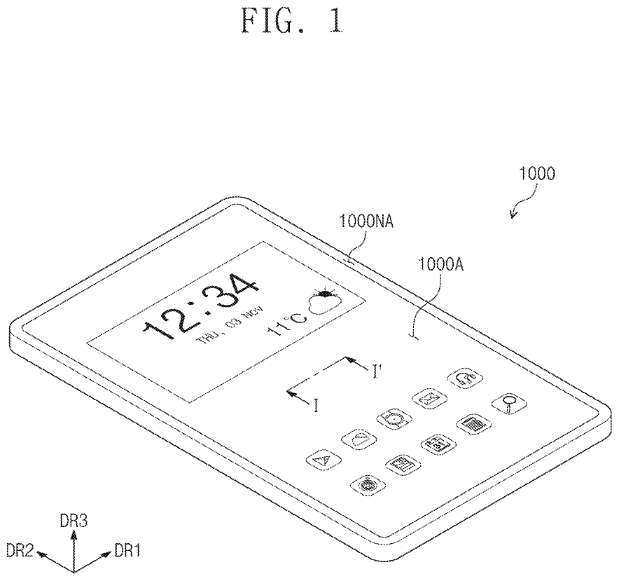

FIG. 1 is a perspective view illustrating an electronic device 1000 according to an embodiment of the present disclosure.

Referring to FIG. 1, the electronic device 1000 may be a device that is activated by an electrical signal. For example, the electronic device 1000 may include a mobile phone, a foldable mobile phone, a notebook, a television, a tablet, an automotive navigation system, a game console, or a wearable device, but the present disclosure is not limited thereto. An example in which the electronic device 1000 is a mobile phone is illustrated in FIG. 1.

An active area 1000A and a peripheral area (or non-active area) 1000NA may be defined in the electronic device 1000. The electronic device 1000 may display an image through the active area 1000A. The active area 1000A may include a surface defined by a first direction DR1 and a second direction DR2. The peripheral area 1000NA may surround the active area 1000A. In an embodiment of the present disclosure, the peripheral area 1000NA may be omitted.

A thickness direction of the electronic device 1000 may be parallel to a third direction DR3 intersecting the first direction DR1 and the second direction DR2. Accordingly, front surfaces (or top/upper surfaces) and rear surfaces (or bottom/lower surfaces) of members constituting the electronic device 1000 may be defined with respect to the third direction DR3.

The electronic device 1000 that is of a bar type is illustrated in FIG. 1 as an example, but the present disclosure is not limited thereto. For example, descriptions that will be given below may be applied to various electronic devices such as a foldable electronic device 1000, a rollable electronic device 1000, and a slidable electronic device 1000.

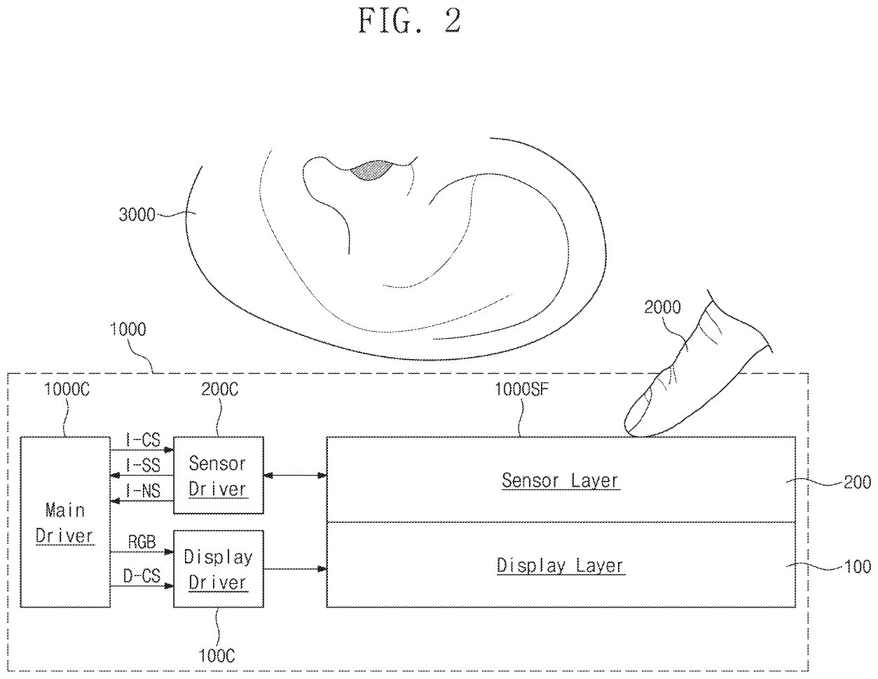

FIG. 2 is a diagram for describing the electronic device 1000 according to an embodiment of the present disclosure.

Referring to FIG. 2, the electronic device 1000 may include a display layer 100, a sensor layer 200, a display driver 100C, a sensor driver 200C, and a main driver 1000C.

The display layer 100 may be a component that substantially generates an image. The display layer 100 may be a light-emitting display layer. For example, the display layer 100 may be an organic light-emitting display layer, an inorganic light-emitting display layer, an organic-inorganic display layer, a quantum dot display layer, a micro-LED display layer, or a nano-LED display layer.

The sensor layer 200 may be disposed on the display layer 100. The sensor layer 200 may sense an external input (or object) (e.g., 2000 or 3000) applied from the outside. The external input 2000 or 3000 may include all the input means capable of providing a change in capacitance. For example, the sensor layer 200 may sense even an input by an active-type input means providing a driving signal, in addition to a passive-type input means such as a body of the user.

The main driver 1000C may control an overall operation of the electronic device 1000. For example, the main driver 1000C may control operations of the display driver 100C and the sensor driver 200C. The main driver 1000C may include at least one microprocessor. Also, the main driver 1000C may further include a graphics processor. The main driver 1000C may be referred to as an “application processor”, a “central processing unit”, or a “main processor”.

The display driver 100C may drive the display layer 100. The display driver 100C may receive image data RGB and a control signal D-CS from the main driver 1000C. The control signal D-CS may include various signals. For example, the control signal D-CS may include an input vertical synchronization signal, an input horizontal synchronization signal, a main clock, a data enable signal, etc. The display driver 100C may generate a vertical synchronization signal and a horizontal synchronization signal for controlling the timing to provide a signal to the display layer 100, based on the control signal D-CS.

The sensor driver 200C may drive the sensor layer 200. The sensor driver 200C may receive a control signal I-CS from the main driver 1000C. The control signal I-CS may include a mode decision signal determining a driving mode of the sensor driver 200C, and a clock signal.

The sensor driver 200C may calculate coordinates of an input based on a signal received from the sensor layer 200 and may provide a coordinate signal I-SS including information about the coordinates to the main driver 1000C. The main driver 1000C processes an operation corresponding to the user input based on the coordinate signal I-SS. For example, the main driver 1000C may drive the display driver 100C such that a new application image is displayed in the display layer 100.

The sensor driver 200C may provide the main driver 1000C with a proximity sensing signal I-NS caused by the object 3000, which is spaced from a surface 1000SF of the electronic device 1000, based on a signal received from the sensor layer 200. The spaced object 3000 may be referred to as a “hovering object”. A user's ear that comes close to the electronic device 1000 is illustrated as an example of the spaced object 3000, but the present disclosure is not limited thereto.

The main driver 1000C may control the display driver 100C such that luminance of an image to be displayed in the display layer 100 decreases or an image is not displayed in the display layer 100. Thus, the main driver 1000C may turn off the display layer 100.

Also, in an embodiment, when it is determined that the object 3000 is sensed, the main driver 1000C may enter a sleep mode. Even though the main driver 1000C enters the sleep mode, the sensor layer 200 and the sensor driver 200C may maintain operations thereof. Accordingly, in the event that the object 3000 is separated from surface 1000SF of the electronic device 1000, the sensor driver 200C may determine the event and may provide the main driver 1000C with a signal releasing the sleep mode of the main driver 1000C.

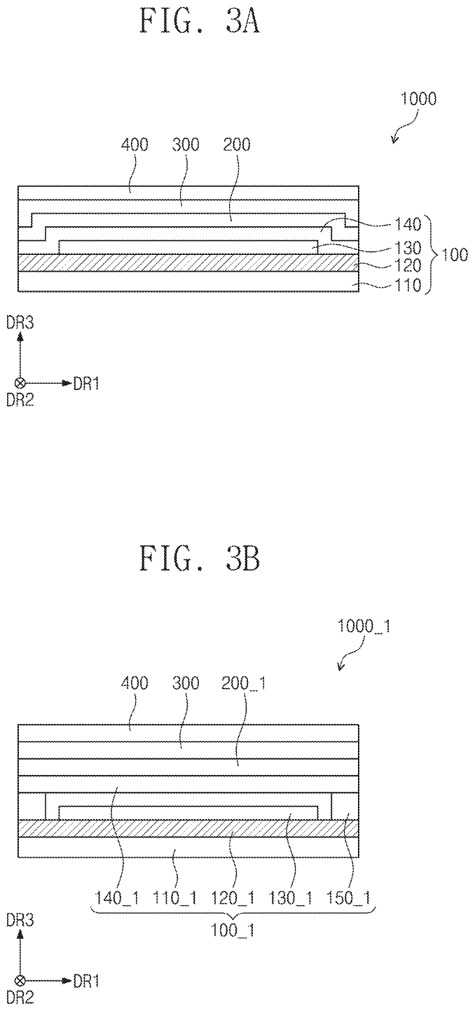

FIG. 3A is a cross-sectional view of the electronic device 1000 according to an embodiment of the present disclosure.

Referring to FIG. 3A, the electronic device 1000 may include the display layer 100, the sensor layer 200, an anti-reflection layer 300, and a window 400.

The display layer 100 may include a base layer 110, a circuit layer 120, a light-emitting element layer 130, and an encapsulation layer 140.

The base layer 110 may be a member that provides a base surface on which the circuit layer 120 is disposed. The base layer 110 may be a glass substrate, a metal substrate, a polymer substrate, etc. However, an embodiment is not limited thereto. For example, the base layer 110 may be an inorganic layer, an organic layer, or a composite material layer.

The circuit layer 120 may be disposed on the base layer 110. The circuit layer 120 may include an insulating layer, a semiconductor pattern, a conductive pattern, a signal line, etc. An insulating layer, a semiconductor layer, and a conductive layer may be formed on the base layer 110 through a coating or deposition process, and the insulating layer, the semiconductor layer, and the conductive layer may be selectively patterned through a plurality of photolithography processes. Afterwards, the insulating layer, the semiconductor pattern, the conductive pattern, and the signal line included in the circuit layer 120 may be formed.

The light-emitting element layer 130 may be disposed on the circuit layer 120. The light-emitting element layer 130 may include a light-emitting element. For example, the light-emitting element layer 130 may include an organic light-emitting material, an inorganic light-emitting material, an organic-inorganic light-emitting material, a quantum dot, a quantum rod, a micro-LED, or a nano-LED.

The encapsulation layer 140 may be disposed on the light-emitting element layer 130. The encapsulation layer 140 may protect the light-emitting element layer 130 from foreign substances such as moisture, oxygen, and dust particles.

The sensor layer 200 may be disposed on the display layer 100. The sensor layer 200 may be formed on the display layer 100 through a successive process. In this case, the sensor layer 200 may be expressed as being directly disposed on the display layer 100. The expression “being directly disposed” may indicate that a third component is not interposed between the sensor layer 200 and the display layer 100 Thus, a separate adhesive member may not be interposed between the sensor layer 200 and the display layer 100. Alternatively, the sensor layer 200 may be coupled to the display layer 100 through an adhesive member. The adhesive member may include a typical adhesive or sticking agent.

The anti-reflection layer 300 may be disposed on the sensor layer 200. The anti-reflection layer 300 may reduce the reflectance of an external light incident from the outside of the electronic device 1000. The anti-reflection layer 300 may be directly disposed on the sensor layer 200. However, the present disclosure is not limited thereto. For example, an adhesive member may be interposed between the anti-reflection layer 300 and the sensor layer 200.

The window 400 may be disposed on the anti-reflection layer 300. The window 400 may include an optically transparent material. For example, the window 400 may include glass or plastic. The window 400 may have a multilayer structure or a single-layer structure. For example, the window 400 may include a plurality of plastic films coupled by an adhesive or may have a glass substrate and a plastic film coupled by an adhesive.

FIG. 3B is a cross-sectional view of an electronic device 1000_1 according to an embodiment of the present disclosure.

Referring to FIG. 3B, the electronic device 1000_1 may include a display layer 100_1, a sensor layer 200_1, the anti-reflection layer 300, and the window 400.

The display layer 100_1 may include a base substrate 110_1, a circuit layer 120_1, a light-emitting element layer 130_1, an encapsulation substrate 140_1, and a coupling member 150_1.

Each of the base substrate 110_1 and the encapsulation substrate 140_1 may be a glass substrate, a metal substrate, or a polymer substrate, but is not particularly limited thereto.

The coupling member 150_1 may be interposed between the base substrate 110_1 and the encapsulation substrate 140_1. The coupling member 150_1 may couple the encapsulation substrate 140_1 to the base substrate 110_1 or the circuit layer 120_1. The coupling member 150_1 may include an inorganic material or an organic material. For example, the inorganic material may include a frit seal, and the organic material may include a photo-curable resin or a photo-plastic resin. However, the material forming the coupling member 150_1 is not limited to the above example.

The sensor layer 200_1 may be directly disposed on the encapsulation substrate 140_1. Here, “being directly disposed” may mean that a third component is not interposed between the sensor layer 200_1 and the encapsulation substrate 140_1. Hence, a separate adhesive member may not be interposed between the sensor layer 200_1 and the display layer 100_1. However, the present disclosure is not limited thereto. For example, an adhesive layer may be further interposed between the sensor layer 200_1 and the encapsulation substrate 140_1.

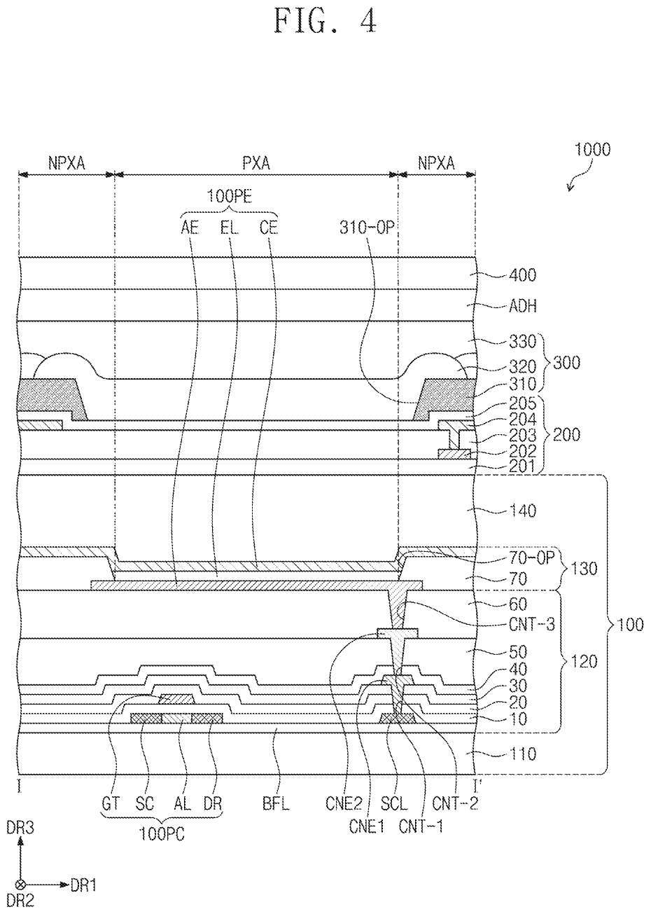

FIG. 4 is a cross-sectional view of the electronic device 1000 according to an embodiment of the present disclosure. For example, FIG. 4 may be a cross-sectional view of the electronic device 1000 taken along I-I′ of FIG. 1.

Referring to FIG. 4, the electronic device 1000 may include the display layer 100, the sensor layer 200, the anti-reflection layer 300, an adhesive layer ADH, and the window 400. The adhesive layer ADH may be interposed between the anti-reflection layer 300 and the window 400. The adhesive layer ADH may include a typical adhesive or sticking agent that has a light transmission property.

At least one inorganic layer is formed on an upper surface of the base layer 110. The inorganic layer may include at least one of aluminum oxide, titanium oxide, silicon oxide, silicon nitride, silicon oxynitride, zirconium oxide, and hafnium oxide. The inorganic layer may be formed of multiple layers. The multiple inorganic layers may constitute a barrier layer and/or a buffer layer. In an embodiment, the display layer 100 is illustrated as including a buffer layer BFL.

The buffer layer BFL may improve a bonding force between the base layer 110 and a semiconductor pattern. The buffer layer BFL may include at least one of silicon oxide, silicon nitride, and silicon oxynitride. For example, the buffer layer BFL may include a structure in which a silicon oxide layer and a silicon nitride layer are stacked alternately.

A semiconductor pattern (SC, AL, and DR) may be disposed on the buffer layer BFL. The semiconductor pattern (SC, AL, and DR) may include polysilicon. However, the present disclosure is not limited thereto. For example, the semiconductor pattern (SC, AL, and DR) may include amorphous silicon, low-temperature polycrystalline silicon, or oxide semiconductor.

FIG. 4 illustrates only a portion of the semiconductor pattern (SC, AL, and DR), and the semiconductor pattern (SC, AL, and DR) may be further disposed in any other area. The semiconductor patterns (SC, AL, and DR) may be arranged across pixels in compliance with a specific rule. The electrical property of the semiconductor pattern (SC, AL, and DR) may be determined differently depending on whether it is doped. The semiconductor pattern (SC, AL, and DR) may include a first area (SC, DR) whose conductivity is high and a second area AL whose conductivity is low. The first area (SC, DR) may be doped with an N-type dopant or a P-type dopant. A P-type transistor may include a doping area doped with a P-type dopant, and an N-type transistor may include a doping area doped with an N-type dopant. The second area AL may be a non-doping area or may be a doping area whose concentration is lower than the concentration of the first area (SC, DR).

The conductivity of the first area (SC, DR) may be greater than the conductivity of the second area AL and may substantially serve as an electrode or a signal line. The second area AL may substantially correspond to an active area (or channel) of a transistor. In other words, a portion of the semiconductor pattern (SC, AL, and DR) may be an active area AL of a transistor, another portion thereof may be a source area SC or a drain area DR of the transistor, and the other portion thereof may be a connection electrode or a connection signal line SCL.

Each pixel may be expressed by an equivalent circuit including 7 transistors, one capacitor, and a light-emitting element, but the equivalent circuit of the pixel may be modified in various embodiments. One transistor 100PC and one light-emitting element 100PE that are included in the pixel are illustrated in FIG. 4 as an example.

The source area SC, the active area AL, and the drain area DR of the transistor 100PC may be formed from the semiconductor pattern (SC, AL, and DR). The source area SC and the drain area DR may extend in directions opposite to each other from the active area AL in a cross-sectional view. A portion of the connection signal line SCL formed from the semiconductor pattern (SC, AL, and DR) is illustrated in FIG. 4. Although not separately illustrated, the connection signal line SCL may be connected to the drain area DR of the transistor 100PC in a plan view.

A first insulating layer 10 may be disposed on the buffer layer BFL. The first insulating layer 10 may overlap a plurality of pixels in common and may cover the semiconductor pattern (SC, AL, and DR). The first insulating layer 10 may be an inorganic layer and/or an organic layer, and may have a single-layer or multilayer structure. The first insulating layer 10 may include at least one of aluminum oxide, titanium oxide, silicon oxide, silicon nitride, silicon oxynitride, zirconium oxide, and a hafnium oxide. In an embodiment, the first insulating layer 10 may be a silicon oxide layer having a single layer. As well as the first insulating layer 10, an insulating layer of the circuit layer 120 to be described later may be an inorganic layer and/or an organic layer and may have a single-layer or multilayer structure. The inorganic layer may include at least one of the materials described above but is not limited thereto.

A gate GT of the transistor 100PC is disposed on the first insulating layer 10. The gate GT may be a portion of a metal pattern. The gate GT overlaps the active area AL. The gate GT may function as a mask in the process of doping the semiconductor pattern (SC, AL, and DR).

A second insulating layer 20 may be disposed on the first insulating layer 10 and may cover the gate GT. The second insulating layer 20 may overlap the pixels in common. The second insulating layer 20 may be an inorganic layer and/or an organic layer and may have a single-layer or multilayer structure. The second insulating layer 20 may include at least one of silicon oxide, silicon nitride, and silicon oxynitride. In an embodiment, the second insulating layer 20 may have a multilayer structure including a silicon oxide layer and a silicon nitride layer.

A third insulating layer 30 may be disposed on the second insulating layer 20. The third insulating layer 30 may have a single-layer or multilayer structure. In an embodiment, the third insulating layer 30 may have a multilayer structure including a silicon oxide layer and a silicon nitride layer.

A first connection electrode CNE1 may be disposed on the third insulating layer 30. The first connection electrode CNE1 may be connected to the connection signal line SCL through a contact hole CNT-1 penetrating the first, second, and third insulating layers 10, 20, and 30.

A fourth insulating layer 40 may be disposed on the third insulating layer 30. The fourth insulating layer 40 may be a single silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 penetrating the fourth insulating layer 40 and the fifth insulating layer 50.

A sixth insulating layer 60 may be disposed on the fifth insulating layer 50 and may cover the second connection electrode CNE2. The sixth insulating layer 60 may be an organic layer.

The light-emitting element layer 130 may be disposed on the circuit layer 120. The light-emitting element layer 130 may include the light-emitting element 100PE. For example, the light-emitting element layer 130 may include an organic light-emitting material, an inorganic light-emitting material, an organic-inorganic light-emitting material, a quantum dot, a quantum rod, a micro-LED, or a nano-LED. Below, an example in which the light-emitting element 100PE is an organic light-emitting element will be described, but the light-emitting element 100PE is not particularly limited thereto.

The light-emitting element 100PE includes a first electrode AE, an emission layer EL, and a second electrode CE.

The first electrode AE may be disposed on the sixth insulating layer 60. The first electrode AE may be connected to the second connection electrode CNE2 through a contact hole CNT-3 penetrating the sixth insulating layer 60.

A pixel defining layer 70 may be disposed on the sixth insulating layer 60 and may cover a portion of the first electrode AE. An opening 70-OP is defined in the pixel defining layer 70. The opening 70-OP of the pixel defining layer 70 exposes at least a portion of the first electrode AE.

The active area 1000A (refer to FIG. 1) may include an emission area PXA and a non-emission area NPXA adjacent to the emission area PXA. The non-emission area NPXA surrounds the emission area PXA. In an embodiment, the emission area PXA is defined to correspond to the portion of the first electrode AE, which is exposed by the opening 70-OP.

The emission layer EL may be disposed on the first electrode AE. The emission layer EL may be disposed in the area defined by the opening 70-OP. As such, the emission layer EL may be independently formed for each pixel. In the case where the emission layer EL is independently formed for each pixel, each of the emission layers EL may emit light of a blue color, a red color, and/or a green color. However, the present disclosure is not limited thereto. For example, the emission layer EL may be commonly connected to the pixels. In this case, the emission layer EL may provide a blue light or may provide a white light.

The second electrode CE may be disposed on the emission layer EL. The second electrode CE may have an integrated shape and may be included in a plurality of pixels in common.

Although not illustrated, a hole control layer may be interposed between the first electrode AE and the emission layer EL. The hole control layer may be disposed in common in the emission area PXA and the non-emission area NPXA. The hole control layer may include a hole transport layer and may further include a hole injection layer. An electron control layer may be interposed between the emission layer EL and the second electrode CE. The electron control layer may include an electron transport layer and may further include an electron injection layer. The hole control layer and the electron control layer may be formed, in common, in a plurality of pixels by using an open mask or inkjet process.

The encapsulation layer 140 may be disposed on the light-emitting element layer 130. The encapsulation layer 140 may include an inorganic layer, an organic layer, and an inorganic layer sequentially stacked, and layers constituting the encapsulation layer 140 are not limited thereto. The inorganic layers may protect the light-emitting element layer 130 from moisture and oxygen, and the organic layer may protect the light-emitting element layer 130 from a foreign material such as dust particles. The inorganic layers may include a silicon nitride layer, a silicon oxynitride layer, a silicon oxide layer, a titanium oxide layer, or an aluminum oxide layer. The organic layer may include an acrylic-based organic layer but is not limited thereto.

The sensor layer 200 may include a base layer 201, a first conductive layer 202, a sensing insulating layer 203, a second conductive layer 204, and a cover insulating layer 205.

The base layer 201 may be an inorganic layer including at least one of silicon nitride, silicon oxynitride, and silicon oxide. Alternatively, the base layer 201 may be an organic layer including epoxy resin, acrylate resin, or imide-based resin. The base layer 201 may have a single-layer structure or may have a structure in which multiple layers are stacked in the third direction DR3.

Each of the first conductive layer 202 and the second conductive layer 204 may have a single-layer structure or may have a structure in which multiple layers are stacked in the third direction DR3.

A conductive layer of a single-layer structure may include a metal layer or a transparent conductive layer. The metal layer may include molybdenum, silver, titanium, copper, aluminum, or an alloy thereof. The transparent conductive layer may include transparent conductive oxide such as indium tin oxide (ITO), indium zinc oxide (IZO), zinc oxide (ZnO), or indium zinc tin oxide (IZTO). In addition, the transparent conductive layer may include conductive polymer such as poly (3,4-ethylenedioxythiophene) (PEDOT), metal nanowire, graphene, etc.

The conductive layer of the multilayer structure may include metal layers. The metal layers may have, for example, a three-layer structure of titanium/aluminum/titanium. The conductive layer of the multilayer structure may include at least one metal layer and at least one transparent conductive layer.

At least one of the sensing insulating layer 203 and the cover insulating layer 205 may include an inorganic layer. The inorganic layer may include at least one of aluminum oxide, titanium oxide, silicon oxide, silicon nitride, silicon oxynitride, zirconium oxide, and hafnium oxide.

At least one of the sensing insulating layer 203 and the cover insulating layer 205 may include an organic layer. The organic layer may include at least one of acrylic-based resin, methacrylic-based resin, polyisoprene, vinyl-based resin, epoxy-based resin, urethane-based resin, cellulose-based resin, siloxane-based resin, polyimide-based resin, polyamide-based resin, and perylene-based resin.

The anti-reflection layer 300 may be disposed on the sensor layer 200. The anti-reflection layer 300 may include a division layer 310, a plurality of color filters 320, and a planarization layer 330.

The division layer 310 may be disposed to overlap a conductive pattern of the second conductive layer 204. The cover insulating layer 205 may be interposed between the division layer 310 and the second conductive layer 204. In another embodiment of the present disclosure, the cover insulating layer 205 may be omitted.

The division layer 310 may prevent reflection of the external light by the second conductive layer 204. A material forming the division layer 310 is not particularly limited as long as it is a material that absorbs a light. The division layer 310 may be a layer having a black color; in an embodiment, the division layer 310 may include a black coloring agent. The black coloring agent may include a black dye and a black pigment. The black coloring agent may include metal such as carbon black or chrome or an oxide thereof.

A division opening 310-OP may be defined in the division layer 310. The division opening 310-OP may overlap the emission layer EL. The color filter 320 may overlap the division opening 310-OP. The color filter 320 may transmit a light provided from the emission layer EL overlapping the color filter 320.

The planarization layer 330 may cover the division layer 310 and the color filter 320. The planarization layer 330 may include an organic material and may provide a flat surface on an upper surface of the planarization layer 330. In an embodiment, the planarization layer 330 may be omitted.

In an embodiment of the present disclosure, the anti-reflection layer 300 may include a reflection control layer (or reflection adjusting layer) instead of the color filters 320. For example, the color filters 320 illustrated in FIG. 4 may be omitted, and the reflection control layer may be added to a place where the color filters 320 are omitted. The reflection control layer may selectively absorb a light reflected from the inside of a display panel and/or an electronic device or a light belonging to a partial band from among a light incident from the outside of the display panel and/or the electronic device.

For example, the reflection control layer may absorb a light of a first wavelength range from 490 nm to 505 nm and a light of a second wavelength range from 585 nm to 600 nm such that the light transmittance in the first wavelength range and the second wavelength range is 40% or less. The reflection control layer may absorb a light of a wavelength being out of wavelength ranges of red, green, and blue lights emitted from the emission layer EL. As described above, the reflection control layer may absorb a light whose wavelength does not belong to the wavelength range of the red, green, or blue light emitted from the emission layer EL, thus preventing or minimizing the decrease in luminance of the display panel and/or the electronic device. In addition, the decrease in luminous efficiency of the display panel and/or the electronic device may be prevented or minimized, and visibility may be improved.

The reflection control layer may include an organic material layer including dye, pigment, or a combination thereof. The reflection control layer may include a tetraazaporphyrin (TAP)-based compound, a porphyrin-based compound, a metal porphyrin-based compound, an oxazine-based compound, a squarylium-based compound, a triarylmethane-based compound, a polymethine-based compound, an anthraquinone-based compound, a phthalocyanine-based compound, a perylene-based compound, a xanthene-based compound, a diimmonium-based compound, a dipyrromethene-based compound, a cyanine-based compound, and combinations thereof.

In an embodiment, the reflection control layer may have transmittance of about 64% to about 72%. The transmittance of the reflection control layer may be adjusted by the amount of pigment and/or dye included in the reflection control layer.

In an embodiment of the present disclosure, the anti-reflection layer 300 may include a retarder and/or a polarizer. The anti-reflection layer 300 may include at least one polarizing film. In this case, the anti-reflection layer 300 may be attached to the sensor layer 200 through an adhesive layer.

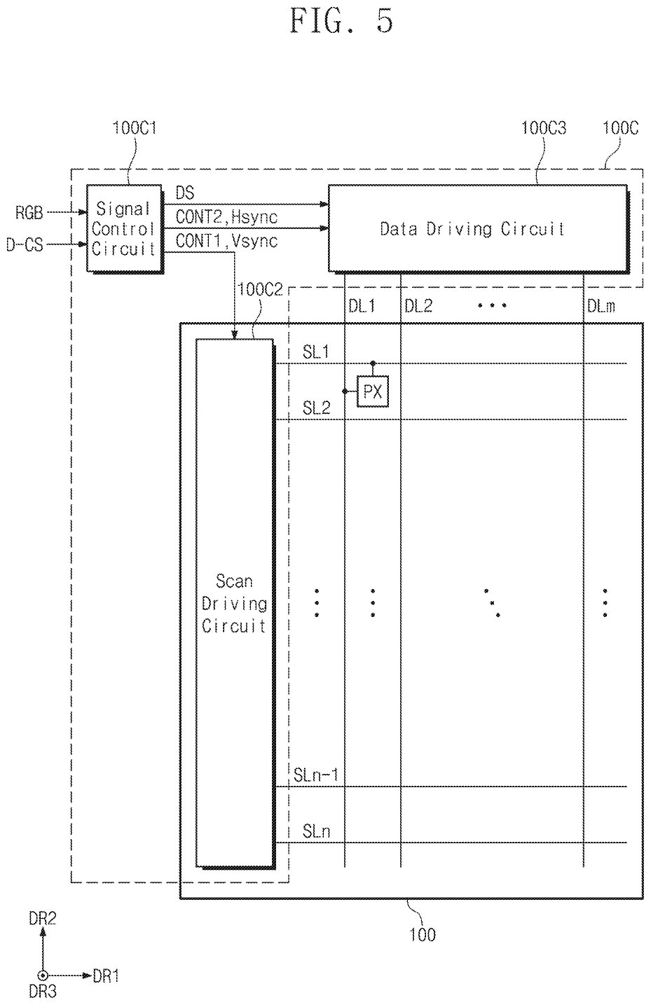

FIG. 5 is a block diagram of the display layer 100 and the display driver 100C according to an embodiment of the present disclosure.

Referring to FIG. 5, the display layer 100 may include a plurality of scan lines SL1 to SLn, a plurality of data lines DL1 to DLm, and a plurality of pixels PX. Each of the pixels PX is connected to a corresponding data line among the plurality of data lines DL1 to DLm and may be connected to a corresponding scan line among the plurality of scan lines SL1 to SLn. Herein, “n” may be an integer of 2 or more, and “m” may be an integer of 2 or more. In an embodiment of the present disclosure, the display layer 100 may further include emission control lines, and the display driver 100C may further include an emission driving circuit that provides control signals to the emission control lines. A configuration of the display layer 100 is not particularly limited.

Each of the scan lines SL1 to SLn may extend in the first direction DR1, and the scan lines SL1 to SLn may be arranged to be spaced from each other in the second direction DR2. The data lines DL1 to DLm may extend in the second direction DR2, and the data lines DL1 to DLm may be arranged to be spaced from each other in the first direction DR1.

The display driver 100C may include a signal control circuit 100C1, a scan driving circuit 100C2, and a data driving circuit 100C3.

The signal control circuit 100C1 may receive the image data RGB and the control signal D-CS from the main driver 1000C (refer to FIG. 2). The control signal D-CS may include various signals. For example, the control signal D-CS may include an input vertical synchronization signal, an input horizontal synchronization signal, a main clock, a data enable signal, etc.

The signal control circuit 100C1 may generate a first control signal CONT1 and a vertical synchronization signal Vsync based on the control signal D-CS and may output the first control signal CONT1 and the vertical synchronization signal Vsync to the scan driving circuit 100C2.

The signal control circuit 100C1 may generate a second control signal CONT2 and a horizontal synchronization signal Hsync based on the control signal D-CS and may output the second control signal CONT2 and the horizontal synchronization signal Hsync to the data driving circuit 100C3.

Also, the signal control circuit 100C1 may provide the data driving circuit 100C3 with a driving signal DS that is obtained by processing the image data RGB so as to be appropriate for an operation condition of the display layer 100. The first control signal CONT1 and the second control signal CONT2, which are signals used for operations of the scan driving circuit 100C2 and the data driving circuit 100C3, are not particularly limited.

The scan driving circuit 100C2 drives the plurality of scan lines SL1 to SLn in response to the first control signal CONT1 and the vertical synchronization signal Vsync. In an embodiment of the present disclosure, the scan driving circuit 100C2 may be formed in the same process as the circuit layer 120 (refer to FIG. 4) in the display layer 100, but the present disclosure is not limited thereto. For example, the scan driving circuit 100C2 may be implemented with an integrated circuit (IC); for electrical connection with the display layer 100, the integrated circuit may be directly mounted in a given area of the display layer 100 or may be mounted on a separate printed circuit board in a chip-on-film (COF) manner.

The data driving circuit 100C3 may output grayscale voltages to the data lines DL1 to DLm in response to the second control signal CONT2, the horizontal synchronization signal Hsync, and the driving signal DS from the signal control circuit 100C1. The data driving circuit 100C3 may be implemented with an integrated circuit; for electrical connection with the display layer 100, the integrated circuit may be directly mounted in a given area of the display layer 100 or may be mounted on a separate printed circuit board in the chip-on-film manner. However, the present disclosure is not limited thereto. For example, the data driving circuit 100C3 may be formed in the same process as the circuit layer 120 (refer to FIG. 4) in the display layer 100.

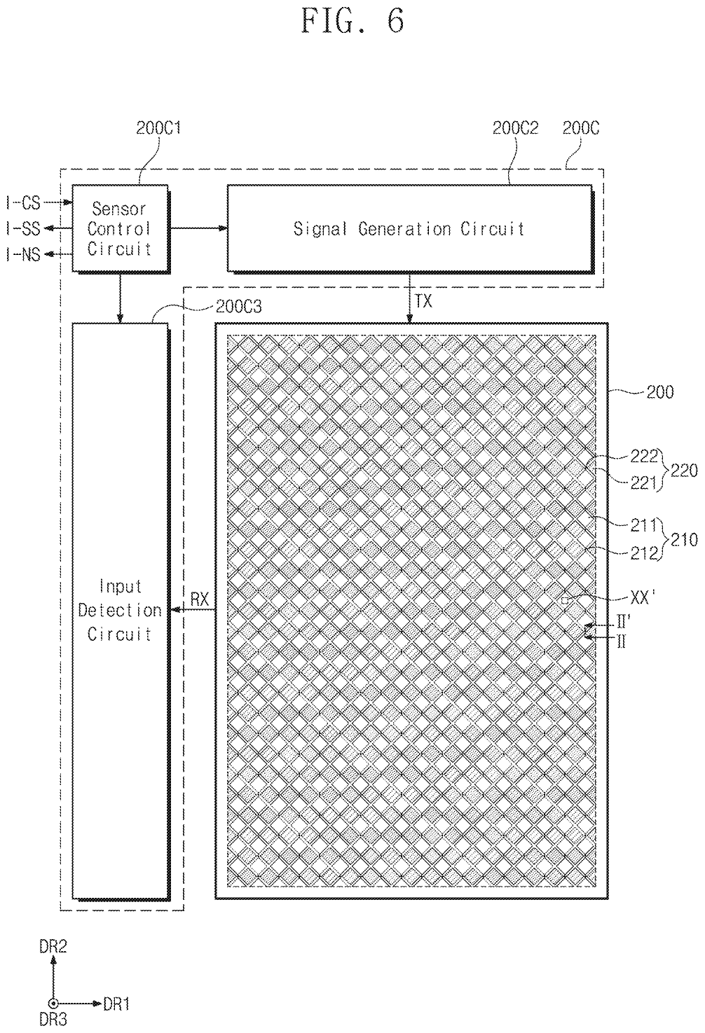

FIG. 6 is a block diagram of the sensor layer 200 and the sensor driver 200C according to an embodiment of the present disclosure.

Referring to FIG. 6, the sensor layer 200 may include a plurality of first electrodes 210 and a plurality of second electrodes 220. Each of the plurality of second electrodes 220 may intersect the plurality of first electrodes 210. Although not illustrated, the sensor layer 200 may further include a plurality of signal lines connected to the plurality of first electrodes 210 and the plurality of second electrodes 220.

Each of the plurality of first electrodes 210 may extend in the second direction DR2, and the plurality of first electrodes 210 may be arranged to be spaced from each in the first direction DR1. Each of the plurality of second electrodes 220 may extend in the first direction DR1, and the plurality of second electrodes 220 may be arranged to be spaced from each in the second direction DR2. FIG. 6 shows 18 first electrodes 210 and 10 second electrodes 220. However, the number of first electrodes 210 and the number of second electrodes 220 are not particularly limited thereto.

Each of the plurality of first electrodes 210 may include a sensing pattern 211 and a bridge pattern 212. Two sensing patterns 211 that are adjacent to each other may be electrically connected to each other by two bridge patterns 212, but the present disclosure is not particularly limited thereto. The sensing pattern 211 may be included in the second conductive layer 204 (refer to FIG. 4), and the bridge pattern 212 may be included in the first conductive layer 202 (refer to FIG. 4).

Each of the plurality of second electrodes 220 may include a first portion 221 and a second portion 222. The first portion 221 and the second portion 222 may have an integrated shape and may be disposed on the same layer. For example, the first portion 221 and the second portion 222 may be included in the second conductive layer 204 (refer to FIG. 4). Two bridge patterns 212 may be insulated from the second portion 222 and may intersect the second portion 222. The first portion 221 may be referred to as a “sensing portion”, and the second portion 222 may be referred to as a “connection portion”. Alternatively, the sensing pattern 211 may be referred to as a “first sensing pattern”; the bridge pattern 212 may also be referred to as a “first bridge pattern”; the first portion 221 may be referred to as a “second sensing pattern”; and, the second portion 222 may be referred to as a “second bridge pattern”.

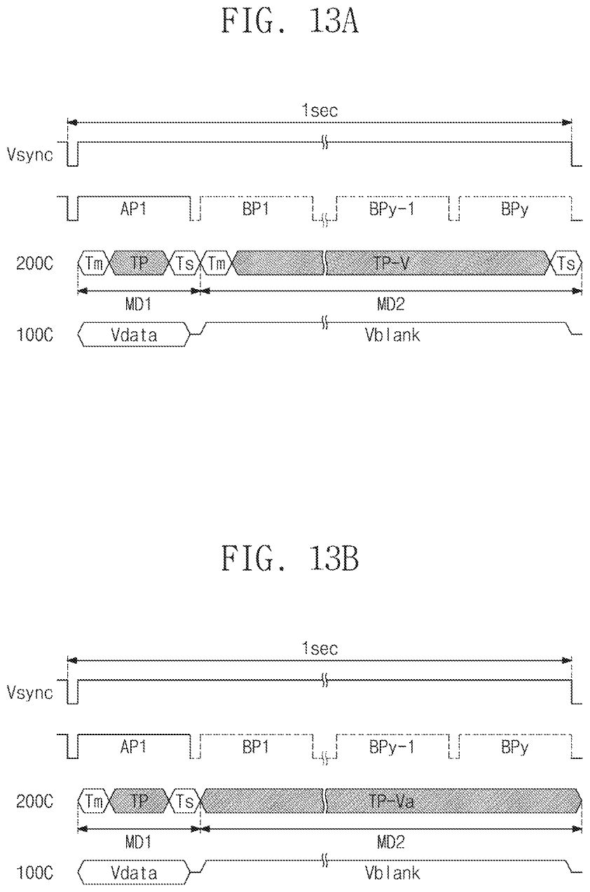

In an embodiment of the present disclosure, the sensor driver 200C may selectively operate in a touch sensing mode or a proximity sensing mode. The sensor driver 200C may receive the control signal I-CS from the main driver 1000C (shown in FIG. 2). In the touch sensing mode, the sensor driver 200C may provide the main driver 1000C with the coordinate signal I-SS. In the proximity sensing mode, the sensor driver 200C may provide the main driver 1000C with a proximity coordinate signal I-NS caused by the spaced object 3000 (refer to FIG. 2). Thus, the sensor layer 200 that operates in the proximity sensing mode may be utilized as a proximity sensor. In this case, the proximity sensor for proximity sensing may be omitted in the electronic device 1000 (refer to FIG. 1), and thus, manufacturing cost of the electronic device 1000 may be reduced. Herein, “proximity sensing mode” means a mode intended entirely for proximity sensing, or for both proximity sensing and touch sensing. Thus, a proximity sensing mode may include both proximity sensing periods (e.g., TP and TP-V in FIG. 13A) and touch sensing periods (e.g., periods Tm and Ts in FIG. 13A). Note that the same or different transmit signals Tx may be used for touch sensing as compared to proximity sensing. For instance, if the same transmit signals are used for both proximity and touch sensing, a proximity of an object may be sensed by sensing a capacitance change higher than a first threshold, and a touch may be sensed by sensing a capacitance change higher than a second threshold (which is higher than the first threshold). On the other hand, different transmit signals for touch sensing as opposed to proximity sensing may have different respective frequencies and/or different respective power levels to optimize touch sensing during touch sensing periods and proximity sensing during proximity sensing periods. In any case, proximity sensing may employ different processing operations than touch sensing.

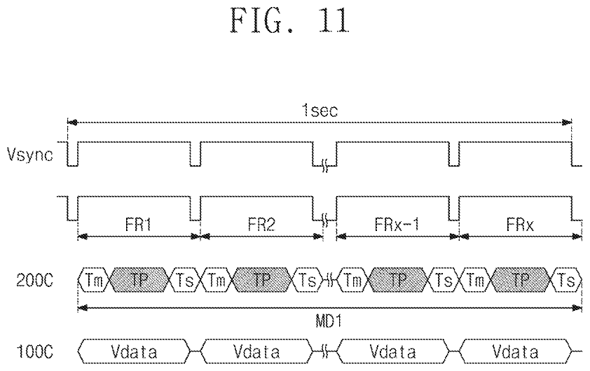

In an embodiment of the present disclosure, the proximity sensing mode may include a first mode and a second mode different from the first mode. This will be described in detail later. In an embodiment of the present disclosure, the sensor driver 200C may operate in synchronization with the display driver 100C (refer to FIG. 5). For example, in the proximity sensing mode, when the frame frequency of the display layer 100 is adjusted to decrease, the sensor driver 200C may operate in the second mode in synchronization with a “blank period”. Herein, a blank period is a period in which data is not provided to a data driving circuit. Herein, in a proximity sensing mode in accordance with the inventive concept, when the frame frequency of the display layer 100 is said to be “adjusted to decrease”, “adjusted lower”, etc., the frame frequency may be decreased (e.g., compared to a state in which no object approach has been detected) by including blank periods (e.g., BP1 in FIG. 13A) within frames. Although a blank period(s) is included in a frame, the duration for an active period AP, during which data is provided, may remain unchanged, whereby the frame periods are lengthened, and the frame frequency is reduced (see, e.g., frame frequency reduction between FIGS. 11 and 13A). It is further noted here that a blank period is different than a “vertical blanking period” (e.g., the low level nulls of the Vsync signal in FIGS. 11, 13A, etc. separating adjacent Vsync pulses of respective adjacent frames).

Alternatively, in an embodiment of the present disclosure, the sensor driver 200C may be driven separately without synchronization with the display driver 100C. For example, in the proximity sensing mode, when the frame frequency of the display layer 100 is adjusted to decrease, the display layer 100 may include a blank period where data is not provided. In this case, the sensor driver 200C may detect the blank period; when it is determined that the blank period is detected, the sensor driver 200C may operate in the second mode.

The sensor driver 200C may be implemented with an integrated circuit (IC); for electrical connection with the sensor layer 200, the integrated circuit may be directly mounted in a given area of the sensor layer 200 or may be mounted on a separate printed circuit board in a chip-on-film (COF) manner.

The sensor driver 200C may include a sensor control circuit 200C1, a signal generation circuit 200C2, and an input detection circuit 200C3. The sensor control circuit 200C1 may control operations of the signal generation circuit 200C2 and the input detection circuit 200C3 based on the control signal I-CS.

The signal generation circuit 200C2 may output transmit signals TX to the first electrodes 210 of the sensor layer 200. The input detection circuit 200C3 may receive sensing signals RX from the sensor layer 200. For example, the input detection circuit 200C3 may receive the sensing signals RX from the second electrodes 220.

The input detection circuit 200C3 may convert an analog signal into a digital signal. For example, the input detection circuit 200C3 amplifies a received analog signal and then filters the amplified signal. That is, the input detection circuit 200C3 may convert the filtered signal into a digital signal.

In the touch sensing mode, the signal generation circuit 200C2 may sequentially output the transmit signals TX to the first electrodes 210, the input detection circuit 200C3 may receive the sensing signals RX from the second electrodes 220 whenever each of the transmit signals TX is provided to the first electrode 210 corresponding thereto. Accordingly, the sensor driver 200C may detect coordinate information of the input 2000 (refer to FIG. 2).

In the proximity sensing mode, the signal generation circuit 200C2 may sequentially output the transmit signals TX to the first electrodes 210 or may simultaneously output the transmit signals TX to some of the first electrodes 210. The waveform of the transmit signals TX in the touch sensing mode and the waveform of the transmit signals TX in the proximity sensing mode may be different from each other. For example, in the case of proximity sensing, this may involve sensing the object 3000 (refer to FIG. 2) coming close to the surface of the electronic device 1000, for example, movement and/or close presence of the user's ear or cheek with respect to the surface. The variations in capacitance due to the object 300 coming close to the surface of the electronic device 1000 may be smaller than the variations in capacitance due to the touch input 2000. Accordingly, the waveform of the transmit signals TX may be changed to improve sensitivity of proximity sensing.

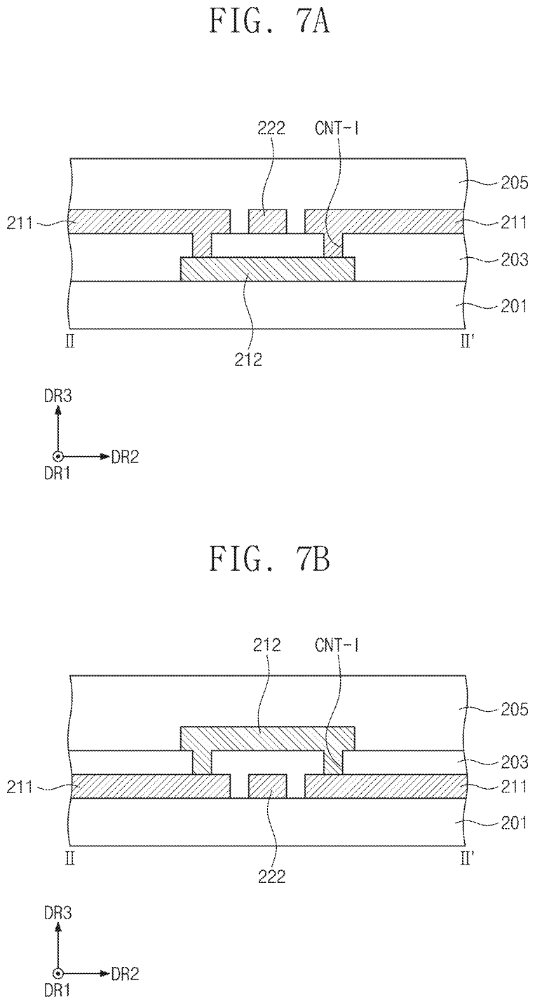

FIG. 7A is a cross-sectional view of a sensor layer according to an embodiment of the present disclosure, which is taken along line II-II′ of FIG. 6.

Referring to FIGS. 6 and 7A, the sensor layer 200 may have a bottom bridge structure. For example, the bridge pattern 212 may be included in the first conductive layer 202 (refer to FIG. 4). The first portion 221, the second portion 222, and the sensing pattern 211 may be included in the second conductive layer 204 (refer to FIG. 4). The sensing pattern 211 may be connected to the bridge pattern 212 through a contact hole CNT-I penetrating the sensing insulating layer 203.

FIG. 7B is a cross-sectional view of a sensor layer according to an embodiment of the present disclosure, which is taken along line II-II′ of FIG. 6.

Referring to FIGS. 6 and 7B, the sensor layer 200 may have a top bridge structure. For example, the bridge pattern 212 may be included in the second conductive layer 204 (refer to FIG. 4). The first portion 221, the second portion 222, and the sensing pattern 211 may be included in the first conductive layer 202 (refer to FIG. 4). The bridge pattern 212 may be connected to the sensing pattern 211 through the contact hole CNT-I penetrating the sensing insulating layer 203.

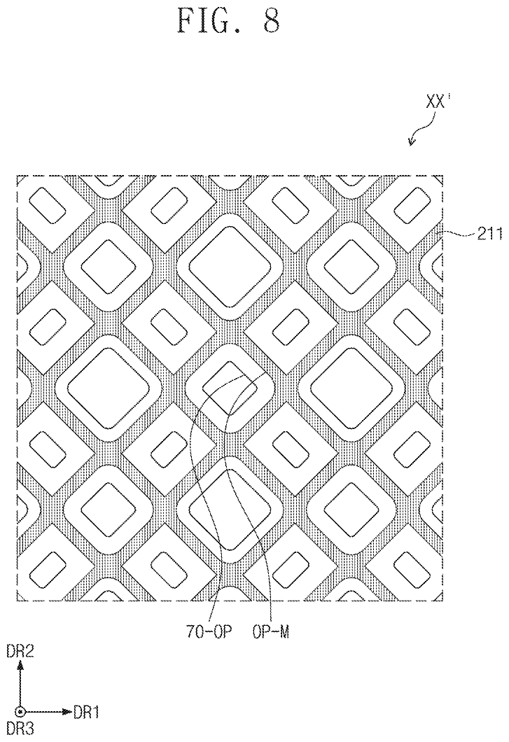

FIG. 8 is an enlarged plan view of area XX′ illustrated in FIG. 6.

Referring to FIGS. 6 and 8, the sensing pattern 211 may have a mesh structure. An opening OP-M may be defined in the sensing pattern 211. One opening OP-M may overlap the opening 70-OP defined in the pixel defining layer 70 (refer to FIG. 4). However, this is only an example. For example, one opening OP-M may overlap the plurality of openings 70-OP. Each of the bridge pattern 212, the first portion 221, and the second portion 222 may have a mesh structure similar to that of the sensing pattern 211.

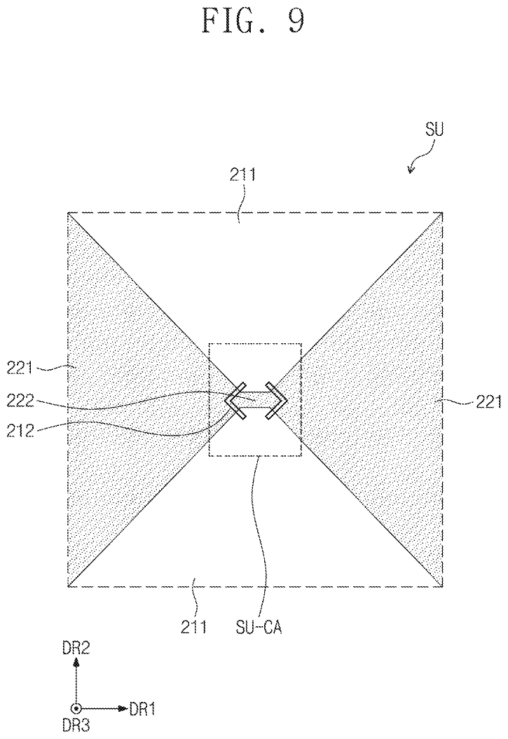

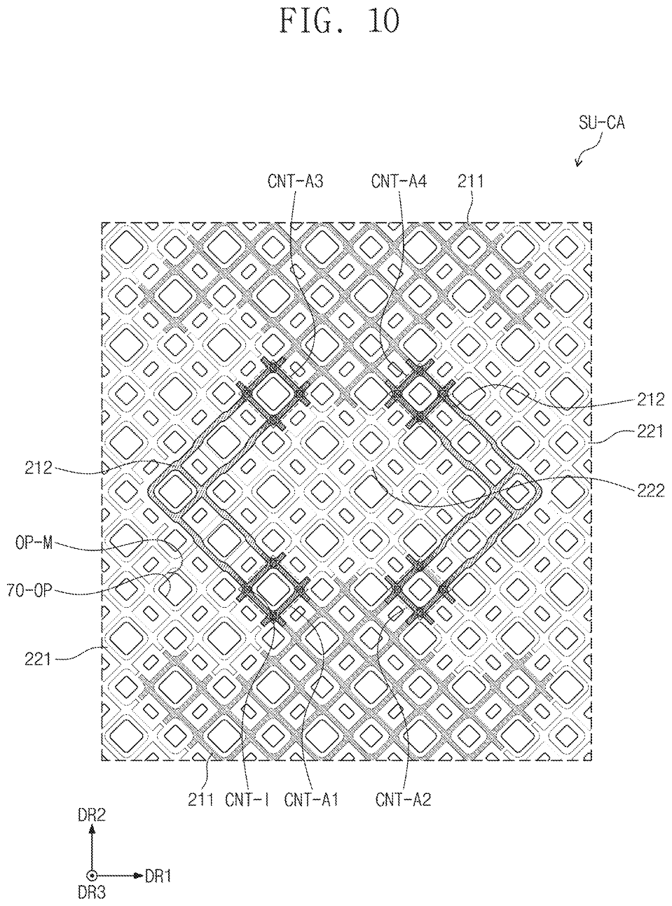

FIG. 9 is a plan view of a sensing unit SU according to an embodiment of the present disclosure. FIG. 10 is an enlarged plan view of a cross area SU-CA of the sensing unit SU according to an embodiment of the present disclosure.

Referring to FIGS. 6, 9, and 10, the sensor layer 200 may be divided into a plurality of sensing units SU. Each of the sensing units SU may include a corresponding cross area SU-CA among cross areas of the first electrodes 210 and the second electrodes 220. The cross area SU-CA may refer to an area where the bridge pattern 212 is disposed.

The sensing unit SU may include one half of the first portion 221, the second portion 222, the other half of the first portion 221 facing one half of the first portion 221 with the second portion 222 interposed therebetween, one half of the sensing pattern 211, two bridge patterns 212, and the other half of the sensing pattern 211.

The two bridge patterns 212 may connect the two sensing patterns 211. First to fourth connection areas CNT-A1, CNT-A2, CNT-A3, and CNT-A4 are provided between the two bridge patterns 212 and the two sensing patterns 211. Four contact holes CNT-I may be formed in the first to fourth connection areas CNT-A1, CNT-A2, CNT-A3, and CNT-A4, respectively. However, this is only an example. For example, the two sensing patterns 211 may be electrically connected by one bridge pattern. Also, in another embodiment of the present disclosure, the two sensing patterns 211 may be electrically connected by three or more bridge patterns.

FIG. 11 is a diagram for describing operations of the display driver 100C and the sensor driver 200C according to an embodiment of the present disclosure.

Referring to FIGS. 2 and 11, operations of the display driver 100C and the sensor driver 200C are illustrated as an example. The embodiment illustrated in FIG. 11 may correspond to a state before an operating frequency of the display layer 100 and the display driver 100C is adjusted, in the proximity sensing mode.

A driving frequency (alternatively referred to as a “display frequency” or a “frame frequency”) of the display layer 100 may be determined by the vertical synchronization signal Vsync. For example, when the driving frequency of the display layer 100 is 60 Hz, a period of each of display frames FR1, FR2, ˜, FRx-1, and FRx may be about 16.67 ms ( 1/60 seconds). Herein, “x” may be an integer of 4 or more, e.g., 60 for a 60 Hz frame frequency. In the display frames FR1, FR2, ˜, FRx-1, and FRx, “˜” may schematically indicate omitted elements between FR2 and FRx-1.

The display driver 100C may provide the display layer 100 with data Vdata corresponding to each of the display frames FR1, FR2, ˜, FRx-1, and FRx. For example, the data Vdata may be grayscale voltages that are provided to the data lines DL1 to DLm (refer to FIG. 5).

The sensor driver 200C may operate in a first mode MD1. The first mode MD1, which is one of a plurality of proximity sensing modes, may include a first touch sensing period Tm, a second touch sensing period Ts, and a first proximity sensing period TP. The first touch sensing period Tm may be a “mutual-cap” sensing period, involving mutual capacitance based sensing, and the second touch sensing period Ts may be a “self-cap” sensing period, which involves self-capacitance based sensing. With mutual capacitance based sensing, changes in capacitance between two electrodes may be measured. A user's touch disrupts the field between the two electrodes, reducing the coupling between them and removing mutual capacitance, which is measured by a suitable circuit. With self-capacitance based sensing, a single electrode's capacitance with respect to earth ground may be measured. A user's touch adds capacitance to the electrode, and the added capacitance is measured by a suitable circuit.

An example in which the sensor driver 200C is repeatedly driven based on a driving pattern sequentially including the first touch sensing period Tm, the first proximity sensing period TP, and the second touch sensing period Ts is illustrated in FIG. 11, but the present disclosure is not limited thereto. For example, the order of the first touch sensing period Tm, the first proximity sensing period TP, and the second touch sensing period Ts may be changed. Also, the second touch sensing period Ts may be omitted.

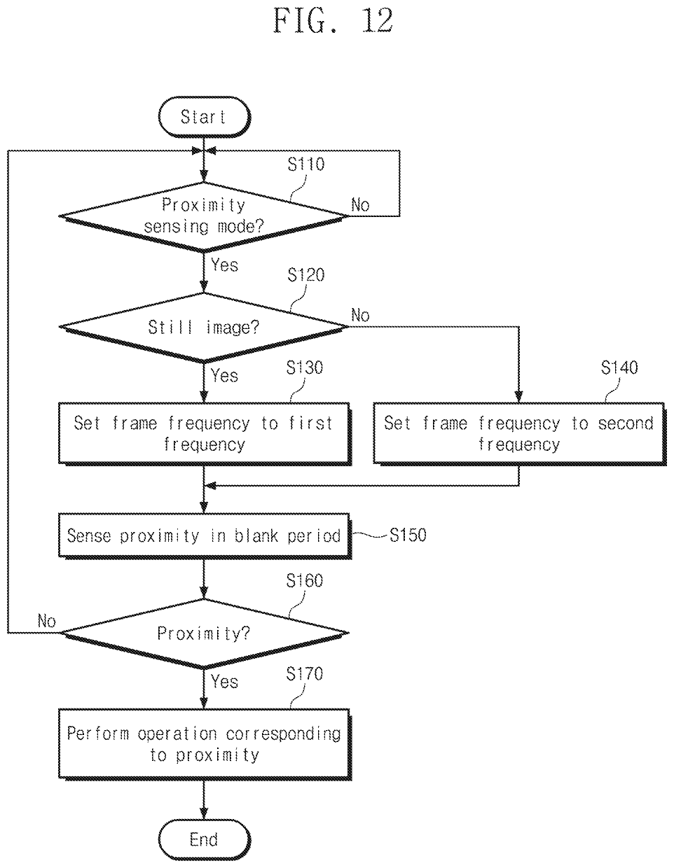

FIG. 12 is a flowchart for describing an operation in a proximity sensing mode according to an embodiment of the present disclosure.

Referring to FIGS. 2 and 12, the sensor driver 200C or the main driver 1000C determines whether the electronic device 1000 enters the proximity sensing mode (S110). For example, when the electronic device 1000 enters a call sending or receiving state, the sensor driver 200C or the main driver 1000C may determine that the electronic device 1000 enters the proximity sensing mode. (Note that if a speaker mode along another application is initiated during the call sending state, this may nullify the entry of the proximity sensing mode because these operations may indicate that the user is continuing to view the display screen and perform screen operations such as icon selection and scrolling, photography, etc.)

When it is determined that the electronic device 1000 enters the proximity sensing mode, the display driver 100C or the main driver 1000C may determine whether an image displayed in the display layer 100 is a still image (S120). For example, the display driver 100C may receive, from the main driver 1000C, a determination signal indicating whether the image displayed in the display layer 100 is the still image. Alternatively, the main driver 1000C may provide the display driver 100C with the determination signal indicating whether the image displayed in the display layer 100 is the still image.

In an embodiment of the present disclosure, the frame frequency of the display layer 100 may be adjusted differently depending on a type of the image displayed in the display layer 100 (or depending on whether an image displayed in the display layer 100 is a still image or a video (a moving image)). For example, when the image displayed in the display layer 100 is the still image, the frame frequency of the display layer 100 may be set to a first frequency (S130). When the image displayed in the display layer 100 is a video, the frame frequency of the display layer 100 may be set to a second frequency (S140). The second frequency may be higher than the first frequency.

In one example, the first frequency may be 20 Hz, and the second frequency may be 30 Hz. Examples of suitable frequency ranges are as follows: when the image displayed in the display layer 100 is the still image, the frame frequency (the first frequency) of the display layer 100 may be set within a range of 1 Hz to 20 Hz. When the image displayed in the display layer 100 is video, the frame frequency (second frequency) of the display layer 100 may be set within a range of 20 Hz to 300 Hz.

When the frame frequency of the display layer 100 decreases, one frame may operate in an active period AP1 (refer to FIG. 13A) where data are received from the display driver 100C and a blank period BP1 (refer to FIG. 13A) where data are not received. In this case, the sensor driver 200C may sense an object's proximity, approach (to within a predetermined proximity distance) or lateral motion in a period overlapping the blank period BP1 (i.e., during the blank period BP1) (S150). For example, in the active period AP1, a noise level may change depending on the contents displayed in the display layer 100, thereby causing the decrease in sensing sensitivity. However, because data are not provided to the display layer 100 in the blank period BP1, the magnitude of the noise may decrease, and the sensing sensitivity may be improved. Accordingly, the sensing sensitivity may be improved by sensing the object's approach during the blank period BP1.

Also, because the noise caused by the display layer 100 in the blank period BP1 is small, during the operation in the proximity sensing mode, it may be possible to decrease magnitudes of the transmit signals Tx (refer to FIG. 6). According to the above description, the sensor layer 200 may be driven at a low voltage, and power consumption of the electronic device 1000 may decrease.

Also, because the noise caused by the display layer 100 in the blank period BP1 is small, a frequency selection range of the transmit signals Tx (refer to FIG. 6) may increase. For example, in the case where a frequency range of the transmit signals Tx is restricted to a specific band to minimize the influence caused by the noise, the frequency selection range may increase as the noise decreases. Accordingly, freedom to select a frequency may be improved.

Also, as proximity sensing is performed in the blank period BP1, signal sensitivity may be improved. Accordingly, the electronic device 1000 may utilize the blank period BP1 as a period for sensing a gesture. For example, the gesture may be referred to as a “3D touch” or a “hovering gesture”. For example, the sensor layer 200 may be configured to sense the following without a direct touch on the electronic device 1000 in the blank period BP1: a gesture in an up-down direction, a gesture in a down-up direction, a gesture in a left-right direction, a gesture in a right-left direction, a clockwise gesture, and a counterclockwise gesture.

Also, as sensing sensitivity is improved, a proximity recognition process time may shorten. This may result in a faster speed at which an operation corresponding to proximity is performed. For example, in the case where the sensor layer 200 senses proximity only in the first mode MD1 illustrated in FIG. 11, whether proximity is detected may be determined based on data received during a time corresponding to a minimum of 10 or more frames, for example, 10 to 15 frames. However, when the electronic device 1000 enters the proximity sensing mode, as described with reference to FIG. 12, whether proximity is detected may be determined by utilizing the blank period BP1 of the display layer 100. Accordingly, whether proximity is detected may be determined based on data received during a time corresponding to 10 frames or less.

The main driver 1000C receives the proximity sensing signal I-NS from the sensor driver 200C and determines whether proximity is detected, based on the proximity sensing signal I-NS (S160). When a determination result indicates that proximity is detected, an operation corresponding to the proximity, for example, an operation to turn off a display screen may be performed (S170). However, when the determination result indicates that proximity is not detected, the procedure proceeds to operation S110 to again start the operation in the proximity sensing mode.

FIG. 13A is a diagram for describing operations of the display driver 100C and the sensor driver 200C according to an embodiment of the present disclosure.

Referring to FIGS. 2, 12, and 13A, when the image displayed in the display layer 100 is the still image, the frame frequency of the display layer 100 may be set to the first frequency.

An example in which the frame frequency of the display layer 100 is set to 1 Hz is illustrated in FIG. 13A. One frame may include the active period AP1 and a plurality of blank periods BP1, ˜, BPy-1, and BPy. The display driver 100C may output the data Vdata to the display layer 100 in the active period AP1 and may not output the data Vdata to the display layer 100 in the blank periods BP1, ˜, BPy-1, and BPy. The period where the data Vdata are not output is indicated as Vblank. As but one example, a time corresponding to the active period AP1 may be about 16.67 ms ( 1/60 seconds), and “y” may be 59.

The sensor driver 200C may operate in the first mode MD1 in a period overlapping the active period AP1 and may operate in a second mode MD2 in a period overlapping the blank periods BP1, ˜, BPy-1, and BPy.

In an embodiment of the present disclosure, the sensor driver 200C may operate in synchronization with the display driver 100C (refer to FIG. 5). For example, in the proximity sensing mode, when the frame frequency of the display layer 100 is adjusted to decrease, the sensor driver 200C may operate in the second mode MD2 in synchronization with the blank periods BP1, ˜, BPy-1, and BPy. However, the present disclosure is not limited thereto. For example, the sensor driver 200C may be driven separately without synchronization with the display driver 100C. For example, in the proximity sensing mode, when the frame frequency of the display layer 100 is adjusted to decrease, the sensor driver 200C may detect whether the blank periods BP1, ˜, BPy-1, and BPy start; when it is determined that the blank periods BP1, ˜, BPy-1, and BPy start, the sensor driver 200C may operate in the second mode MD2. In this case a point in time when an operation in the second mode MD2 is performed may be delayed with respect to an operating time illustrated in FIG. 13A.

In an embodiment of the present disclosure, the second mode MD2 may include the first touch sensing period Tm, the second touch sensing period Ts, and a second proximity sensing period TP-V. The duration of the second proximity sensing period TP-V may be longer than the duration of the first proximity sensing period TP. For example, the second proximity sensing period TP-V may overlap the plurality of blank periods BP1, ˜, BPy-1, and BPy, which are contiguous.

Accordingly, the sensor driver 200C may sense the object's approach (or nearby object) during the blank periods BP1, ˜, BPy-1, and BPy. Because data are not provided to the display layer 100 in the blank periods BP1, ˜, BPy-1, and BPy, the magnitude of the noise may decrease. Accordingly, the proximity sensing sensitivity of the sensor layer 200 may be improved.

FIG. 13B is a diagram for describing operations of the display driver 100C and the sensor driver 200C according to an embodiment of the present disclosure. In the description of FIG. 13B, a difference with FIG. 13A will be described, and the same components described with reference to FIG. 13A are marked by the same reference numerals/signs. Thus, additional description will be omitted to avoid redundancy.

Referring to FIGS. 2 and 13B, the sensor driver 200C may operate in the first mode MD1 in a period overlapping the active period AP1 and may operate in the second mode MD2 in a period overlapping the blank periods BP1, ˜, BPy-1, and BPy.

In an embodiment of the present disclosure, the second mode MD2 may include a second proximity sensing period TP-Va. The second mode MD2 illustrated in FIG. 13B may not include the first touch sensing period Tm and the second touch sensing period Ts.

The duration of the second proximity sensing period TP-Va may be longer than the duration of the first proximity sensing period TP. For example, the second proximity sensing period TP-Va may overlap the plurality of blank periods BP1, ˜, BPy-1, and BPy, which are contiguous.

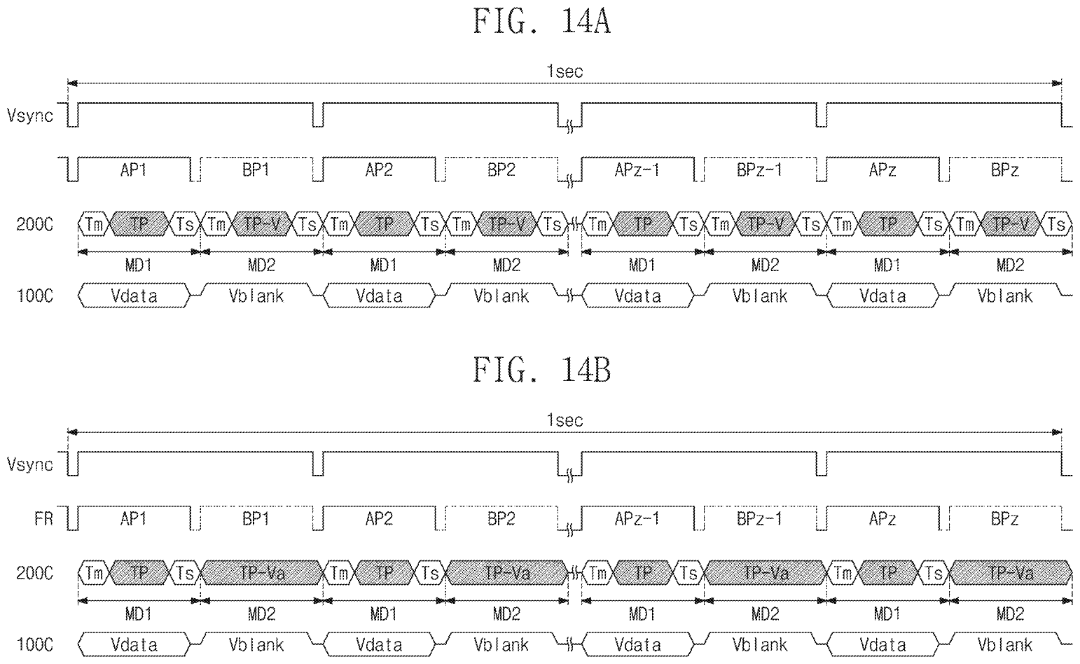

FIG. 14A is a diagram for describing operations of the display driver 100C and the sensor driver 200C according to an embodiment of the present disclosure.

Referring to FIGS. 2, 12, and 14A, when the image displayed in the display layer 100 is the video, the frame frequency of the display layer 100 may be set to the second frequency. An example in which the frame frequency of the display layer 100 is set to 30 Hz is illustrated in FIG. 14A. In this case, one frame may include one active period AP1 and one blank period BP1.

The display driver 100C may output the data Vdata to the display layer 100 in active periods AP1, AP2, ˜, APz-1, and APz and may not output the data Vdata to the display layer 100 in blank periods BP1, BP2, ˜, BPz-1, and BPz. The period where the data Vdata are not output is indicated as Vblank. In an embodiment of the present disclosure, a time corresponding to the active period AP1 may be about 16.67 ms, and “z” may be 30.

The sensor driver 200C may operate in the first mode MD1 in a period overlapping each of the active periods AP1, AP2, ˜, APz-1, and APz and may operate in the second mode MD2 in a period overlapping each of the blank periods BP1, BP2, ˜, BPz-1, and BPz.

The first mode MD1 may include the first touch sensing period Tm, the second touch sensing period Ts, and the first proximity sensing period TP. The second mode MD2 may include the first touch sensing period Tm, the second touch sensing period Ts, and the second proximity sensing period TP-V. The duration of the second proximity sensing period TP-V may be longer than or equal to the duration of the first proximity sensing period TP. In an embodiment of the present disclosure, the duration of the second proximity sensing period TP-V may be equal to the duration of the first proximity sensing period TP.

That is, the sensor driver 200C may sense the object's approach (or nearby object) in the period overlapping each of the blank periods BP1, BP2, ˜, BPz-1, and BPz in time. Because data are not provided to the display layer 100 in the blank periods BP1, BP2, ˜, BPz-1, and BPz, the magnitude of the noise may decrease. Accordingly, the proximity sensing sensitivity of the sensor layer 200 may be improved.

In an embodiment of the present disclosure, the transmit signals TX (refer to FIG. 6) provided to the sensor layer 200 in the first proximity sensing period TP may be different from the transmit signals TX provided to the sensor layer 200 in the second proximity sensing period TP-V. For example, the transmit signals TX provided to the sensor layer 200 in the first proximity sensing period TP may be different in frequency or in magnitude (e.g., amplitude) from the transmit signals TX provided to the sensor layer 200 in the second proximity sensing period TP-V.

FIG. 14B is a diagram for describing operations of a display driver and a sensor driver according to an embodiment of the present disclosure. In the description of FIG. 14B, a difference with FIG. 14A will be described, and the same components already described with reference to FIG. 14A are marked by the same reference numerals/signs. Thus, additional description will be omitted to avoid redundancy.

Referring to FIG. 14B, the sensor driver 200C may operate in the first mode MD1 in a period overlapping each of the active periods AP1, AP2, ˜, APz-1, and APz and may operate in the second mode MD2 in a period overlapping each of the blank periods BP1, BP2, ˜, BPz-1, and BPz.

In an embodiment of the present disclosure, the second mode MD2 may include the second proximity sensing period TP-Va. The duration of the second proximity sensing period TP-Va may be longer than the duration of the first proximity sensing period TP. For example, the second proximity sensing period TP-Va may overlap at least one corresponding blank period among the plurality of blank periods BP1, BP2, ˜, BPz-1, and BPz, which are contiguous.

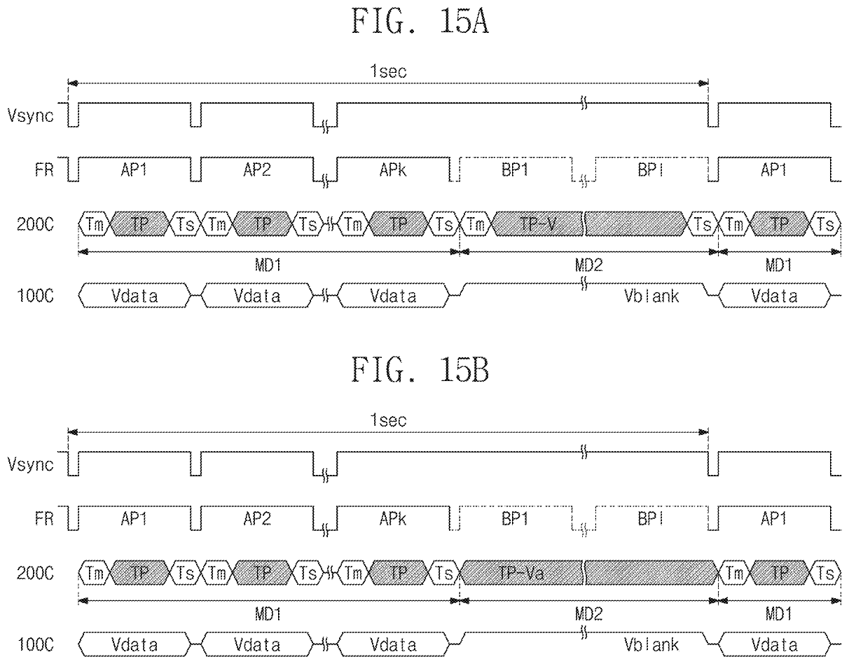

FIG. 15A is a diagram for describing operations of the display driver 100C and the sensor driver 200C according to an embodiment of the present disclosure.

Referring to FIGS. 2, 12, and 15A, when the image displayed in the display layer 100 is the video, the frame frequency of the display layer 100 may be set to the second frequency.

In an embodiment of the present disclosure, the display layer 100 may operate in contiguous active periods AP1, AP2, ˜, APk and may then operate in contiguous blank periods BP1, ˜, BPl. For example, when the frame frequency of the display layer 100 is set to 30 Hz, during 1 second, the display layer 100 may operate in 30 active periods AP1 to AP30 and may then operate in 30 blank periods BP1 to BP30. Thus, “k” may be 30, and “I” may be “30”.

The sensor driver 200C may operate in the first mode MD1 in a period overlapping the active periods AP1, AP2, ˜, APk and may operate in the second mode MD2 in a period overlapping the blank periods BP1, ˜, BPl.

In an embodiment of the present disclosure, the first mode MD1 may include the first touch sensing period Tm, the second touch sensing period Ts, and the first proximity sensing period TP. The second mode MD2 may include the first touch sensing period Tm, the second touch sensing period Ts, and the second proximity sensing period TP-V. The duration of the second proximity sensing period TP-V may be longer than or equal to the duration of the first proximity sensing period TP. For example, the second proximity sensing period TP-V may overlap the plurality of contiguous blank periods BP1, ˜, BPl.

FIG. 15B is a diagram for describing operations of the display driver 100C and the sensor driver 200C according to an embodiment of the present disclosure. In the description of FIG. 15B, a difference with FIG. 15A will be described, and the same components already described with reference to FIG. 15A are marked by the same reference numerals/signs. Thus, additional description will be omitted to avoid redundancy.

In an embodiment of the present disclosure, the second mode MD2 may include the second proximity sensing period TP-Va. The duration of the second proximity sensing period TP-Va may be longer than the duration of the first proximity sensing period TP. For example, the second proximity sensing period TP-Va may overlap the plurality of blank periods BP1, ˜, BPl, which are contiguous.

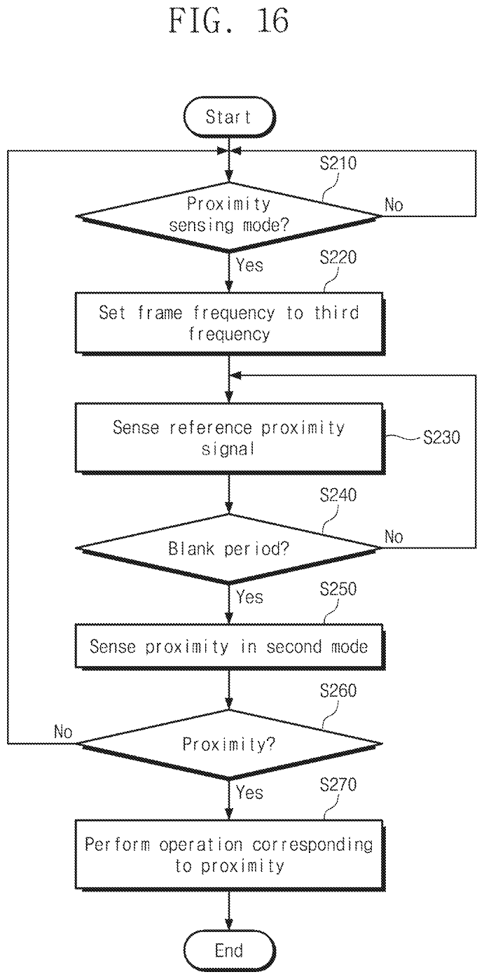

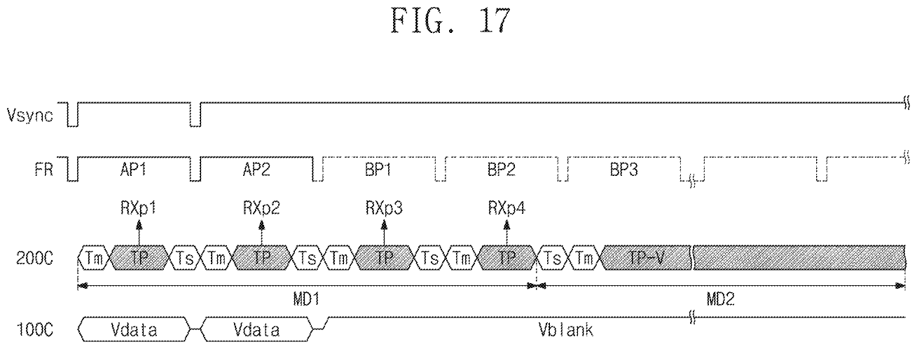

FIG. 16 is a flowchart for describing an operation in a proximity sensing mode according to an embodiment of the present disclosure. FIG. 17 is a diagram for describing operations of the display driver 100C and the sensor driver 200C according to an embodiment of the present disclosure.

Referring to FIGS. 2, 16, and 17, the sensor driver 200C or the main driver 1000C determines whether the electronic device 1000 enters the proximity sensing mode (S210). For example, when the electronic device 1000 enters a call sending or receiving state, the sensor driver 200C or the main driver 1000C may determine that the electronic device 1000 enters the proximity sensing mode.

When the electronic device 1000 enters the proximity sensing mode, the frame frequency of the display layer 100 may be set to a third frequency (S220). The third frequency may be 30 Hz. However, the present disclosure is not limited thereto. In the embodiment illustrated in FIG. 16, an operation of determining whether an image displayed in the display layer 100 is a still image may be omitted, but operation S110, operation S120, operation S130, and operation S140 described with reference to FIG. 12 may be applied instead of operation S210 and operation S220.

The sensor driver 200C may operate in the first mode MD1 and may sense reference proximity signals RXp1, RXp2, RXp3, and RXp4 (S230). The sensor driver 200C may be configured to determine whether the display layer 100 operates in a blank period BP1, BP2, or BP3, based on the reference proximity signals RXp1, RXp2, RXp3, and RXp4. That is, the sensor driver 200C may determine whether the blank period BP1, BP2, or BP3 of the display layer 100 starts, based on the reference proximity signals RXp1, RXp2, RXp3, and RXp4 (S240).

The reference proximity signals RXp1, RXp2, RXp3, and RXp4 may include the first reference proximity signal RXp1 measured in the first active period AP1, the second reference proximity signal RXp2 measured in the second active period 2 following the first active period AP1, the third reference proximity signal RXp3 measured in the first blank period BP1 following the second active period AP2, and the fourth reference proximity signal RXp4 measured in the second blank period BP2 following the first blank period BP1.

The sensor driver 200C may determine whether the display layer 100 operates in the blank period, by comparing the first to fourth reference proximity signals RXp1, RXp2, RXp3, and RXp4; when it is determined that the display layer 100 operates in the blank period, the sensor driver 200C may operate in the second mode MD2. For example, the sensor driver 200C may compare peak-to-peak values of the first to fourth reference proximity signals RXp1, RXp2, RXp3, and RXp4 to a reference voltage stored in advance; when the peak-to-peak value is smaller than the reference voltage, the sensor driver 200C may determine that the display layer 100 operates in the blank period. Alternatively, the sensor driver 200C may compare a difference between two contiguous reference proximity signals; when the difference is smaller than a reference value stored in advance, the sensor driver 200C may determine that the display layer 100 operates in the blank period.

When it is determined that the display layer 100 operates in the blank period, the sensor driver 200C may sense the object's approach in the second mode MD2 (S250). In an embodiment of the present disclosure, when the sensor driver 200C determines that the display layer 100 operates in the blank period, based on a result of comparing the first to fourth reference proximity signals RXp1, RXp2, RXp3, and RXp4, the sensor driver 200C may operate in the second mode MD2 from the third blank period BP3 following the second blank period BP2. However, this is only an example. For example, the sensor driver 200C may operate in the second mode MD2 from the second blank period BP2 depending on a determination operation of the sensor driver 200C.

The main driver 1000C receives the proximity sensing signal I-NS from the sensor driver 200C and determines whether proximity is detected, based on the proximity sensing signal I-NS (S260). When a determination result indicates that proximity is detected, an operation corresponding to the proximity, for example, an operation to turn off a display screen may be performed (S270). However, when the determination result indicates that proximity is not made, the procedure proceeds to operation S210 to again start the operation in the proximity sensing mode.

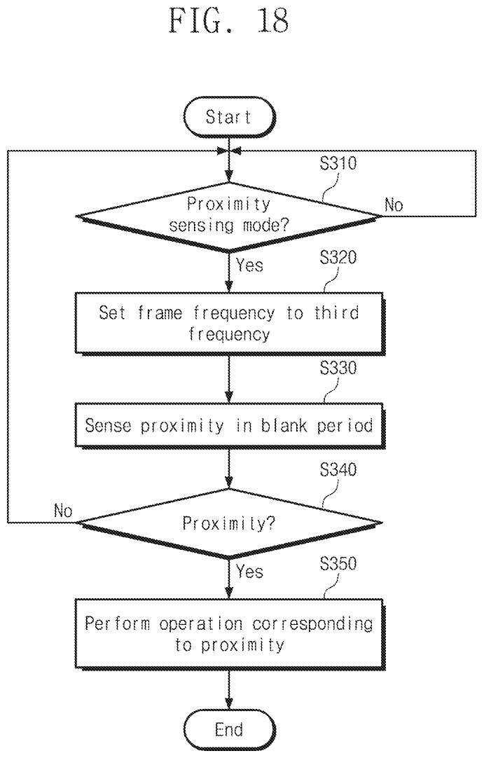

FIG. 18 is a flowchart for describing an operation in a proximity sensing mode according to an embodiment of the present disclosure.

Referring to FIGS. 2 and 18, the sensor driver 200C or the main driver 1000C determines whether the electronic device 1000 enters the proximity sensing mode (S310). For example, when the electronic device 1000 enters a call sending or receiving state, the sensor driver 200C or the main driver 1000C may determine that the electronic device 1000 enters the proximity sensing mode.

When the electronic device 1000 enters the proximity sensing mode, the frame frequency of the display layer 100 may be set to the third frequency (S320). The third frequency may be 30 Hz. However, the present disclosure is not limited thereto. In the embodiment illustrated in FIG. 18, an operation of determining whether an image displayed in the display layer 100 may be omitted.

When the frame frequency of the display layer 100 decreases, one frame may comprise the active period AP1 (refer to FIG. 13A) where data are received from the display driver 100C and the blank period BP1 (refer to FIG. 13A) where data are not received. In this case, the sensor driver 200C may sense object's approach (or a nearby object) in a period overlapping the blank period BP1 in time (S330).

That is, the sensor driver 200C may sense the object's approach (or nearby object) in a period overlapping the blank periods BP1, ˜, BPy-1, and BPy in time. Because data are not provided to the display layer 100 in the blank periods BP1, ˜, BPy-1, and BPy, the magnitude of the noise may decrease. Accordingly, the proximity sensing sensitivity of the sensor layer 200 may be improved. The main driver 1000C receives the proximity sensing signal I-NS from the sensor driver 200C and determines whether proximity is detected, based on the proximity sensing signal I-NS (S340). When a determination result indicates that proximity is detected, an operation corresponding to the proximity, for example, an operation to turn off a display screen may be performed (S350). However, when the determination result indicates that proximity is not detected, the procedure proceeds to operation S310 to again start the operation in the proximity sensing mode.

According to the above description, when an electronic device enters a proximity sensing mode, a frame frequency of a display layer may decrease. One frame may comprise an active period where data are received from a display driver and a blank period where data are not received. In this case, a sensor driver may sense object's approach to within a predetermined proximate distance (or nearby object) during the blank period. Because data are not provided to the display layer in the blank period, the magnitude of the noise may decrease, and sensing sensitivity may be improved. Accordingly, the sensing sensitivity may be improved by sensing the object's approach during the blank period.

Also, because the noise caused by the display layer in the blank period is small, during an operation in the proximity sensing mode, the magnitude of transmit signals may be reduced to reduce power consumption. As a result, a sensor layer may be driven at a low voltage, and power consumption of the electronic device may decrease. Also, in the case where a frequency range of the transmit signals is restricted to a specific band to minimize the influence caused by the noise, a frequency selection range may increase as the noise decreases. Accordingly, freedom to select a frequency may be improved. In addition, as sensing sensitivity is improved, a proximity recognition process time may shorten. This may result in a faster speed at which an operation corresponding to proximity is performed.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device comprising:
a display layer including a plurality of pixels;
a sensor layer disposed on the display layer and including a plurality of first electrodes and a plurality of second electrodes;
a display driver configured to drive the display layer; and
a sensor driver configured to drive the sensor layer and to selectively operate, during a proximity sensing mode, in a first mode or a second mode different from the first mode,
wherein, when the electronic device enters the proximity sensing mode, the display layer operates in an active period in which data are received from the display driver and a blank period in which the data are not received, and
wherein the sensor driver is configured to operate in the second mode in a period overlapping the blank period.

2. The electronic device of claim 1, wherein the first mode includes a touch sensing period and a first proximity sensing period,
wherein the second mode includes a second proximity sensing period, and
wherein a duration of the second proximity sensing period is longer than or equal to a duration of the first proximity sensing period.

3. The electronic device of claim 2, wherein the sensor driver is configured to:
operate in the first mode to obtain a plurality of reference proximity signals; and
determine whether the display layer operates in the blank period based on the plurality of reference proximity signals, if so, the sensor driver operates in the second mode.

4. The electronic device of claim 3, wherein the plurality of reference proximity signals include a first reference proximity signal measured in a first active period, a second reference proximity signal measured in a second active period following the first active period, a third reference proximity signal measured in a first blank period following the second active period, and a fourth reference proximity signal measured in a second blank period following the first blank period, and
wherein the sensor driver determines whether the display layer operates in the blank period by comparing the first to fourth reference proximity signals, and
wherein, when it is determined that the display layer operates in the blank period, the sensor driver operates in the second mode from a third blank period following the second blank period.

5. The electronic device of claim 2, wherein the touch sensing period includes a mutual-cap sensing period and a self-cap sensing period.

6. The electronic device of claim 2, wherein the second mode further includes a mutual-cap sensing period and a self-cap sensing period.

7. The electronic device of claim 2, wherein the second proximity sensing period overlaps a plurality of blank periods, which are contiguous.

8. The electronic device of claim 1, further comprising:
a main driver configured to control an operation of the display driver and an operation of the sensor driver, and
wherein the main driver is configured to determine whether an image displayed in the display layer is a still image or a video.

9. The electronic device of claim 8, wherein, when the image is the still image, a frame frequency of the display layer is set to a first frequency,
wherein, when the image is the video, the frame frequency of the display layer is set to a second frequency higher than the first frequency.

10. The electronic device of claim 9, wherein the first frequency is 20 Hz, and the second frequency is 30 Hz.

11. The electronic device of claim 1, wherein the sensor driver is configured to operate in synchronization with the display driver.

12. An electronic device comprising:
a display layer including a plurality of pixels and configured to operate at a variable frame frequency including a first frame frequency and a second frame frequency lower than the first frame frequency; and
a sensor layer disposed on the display layer and configured to selectively operate, during a proximity sensing mode, in a first mode or a second mode different from the first mode,
wherein the first mode includes a touch sensing period and a first proximity sensing period,
wherein the second mode includes a second proximity sensing period, and
wherein a duration of the second proximity sensing period equals or exceeds a duration of the first proximity sensing period.

13. The electronic device of claim 12, wherein the display layer operating at the second frame frequency operates in an active period where data are received and a blank period where the data are not received,
wherein the first proximity sensing period overlaps the active period, and
wherein the second proximity sensing period overlaps the blank period.

14. The electronic device of claim 13, wherein the second proximity sensing period overlaps a plurality of blank periods, which are contiguous.

15. The electronic device of claim 13, further comprising:
a sensor driver configured to drive the sensor layer,
wherein the sensor driver is configured to:
obtain a plurality of reference proximity signals; and
determine whether the display layer operates in the blank period based on the plurality of reference proximity signals, and
wherein, when it is determined that the display layer operates in the blank period, the sensor driver is configured to change an operating mode of the sensor layer from the first mode to the second mode.

16. The electronic device of claim 13, further comprising:
a display driver configured to drive the display layer;
a sensor driver configured to drive the sensor layer; and
a main driver configured to control an operation of the display driver and an operation of the sensor driver,
wherein the main driver is configured to determine whether an image displayed in the display layer is a still image or a video,
wherein, when the image is the still image, the second frame frequency of the display layer is set to a first frequency,
wherein, when the image is the video, the second frame frequency of the display layer is set to a second frequency higher than the first frequency.

17. A driving method of an electronic device, the method comprising:
displaying an image through a display layer; and
driving, during a proximity sensing mode, a sensor layer disposed on the display layer, in a first mode or a second mode different from the first mode,
wherein the displaying of the image through the display layer includes:
when the electronic device enters the proximity sensing mode, operating in an active period during which the display layer receives data and a blank period during which the display layer does not receive the data, and
wherein the driving of the sensor layer includes:
operating in the second mode in a period overlapping the blank period.

18. The method of claim 17, wherein the first mode includes a touch sensing period and a first proximity sensing period,
wherein the second mode includes a second proximity sensing period, and
wherein a duration of the second proximity sensing period equals or exceeds a duration of the first proximity sensing period.

19. The method of claim 17, wherein the driving of the sensor layer further includes:
operating in the first mode to obtain a plurality of reference proximity signals;
determining whether the display layer operates in the blank period, based on the plurality of reference proximity signals; and
when it is determined that the display layer operates in the blank period, changing from the first mode to the second mode to operate.

20. The method of claim 17, wherein the displaying of the image through the display layer further includes:
when the electronic device enters the proximity sensing mode, determining whether the image is a still image;
when the image is the still image, setting a frame frequency of the display layer to a first frequency; and
when the image is a video, setting the frame frequency of the display layer to a second frequency higher than the first frequency.
